(19) United States
(12) Patent Application Publication
(10) Pub. No.: US 2014/0072343 A1
(43) Pub. Date: Mar. 13, 2014

(54) CHARGING MEMBER, PROCESS CARTRIDGE, AND ELECTROPHOTOGRAPHIC APPARATUS

(71) Applicant: CANON KABUSHIKI KAISHA, Tokyo (JP)

(72) Inventors: Hiroki Masu, Numazu-shi (JP); Masataka Kodama, Mishima-shi (JP); Noriyuki Doi, Numazu-shi (JP); Noriko Suzumura, Mishima-shi (JP); Masahiro Kurachi, Fujisawa-shi (JP); Noriaki Kuroda, Suntou-gun (JP)

(73) Assignee: CANON KABUSHIKI KAISHA, Tokyo (JP)

(21) Appl. No.: 14/084,148

(22) Filed: Nov. 19, 2013

Related U.S. Application Data
(63) Continuation of application No. PCT/JP2013/003202, filed on May 20, 2013.

(30) Foreign Application Priority Data
Jun. 6, 2012 (JP) 2012-129061

(51) Int. Cl. G03G 15/02

(52) U.S. Cl. CPC G03G 15/0233
USPC 399/176

(57) ABSTRACT

Provided is a charging member whose surface is suppressed to adhesion of toner or an external additive and is not contaminated easily, and which is less likely to occur a track due to the contact between the charging member and a photosensitive member in an electrophotographic image. The charging member comprises a support, an elastic layer, and a surface layer, wherein the surface layer comprises: a constitutional unit represented by the following general formula (1); a constitutional unit represented by the following general formula (2); a polymer compound having a bond of Si—O—Ti; and phenyl-modified silicone oil having a particular structure.

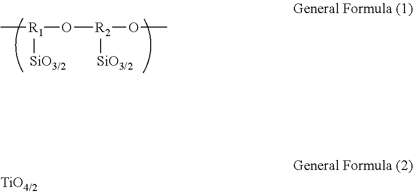

### CROSS-REFERENCE TO RELATED APPLICATIONS

This application is a continuation of International Application No. PCT/JP2013/003202, filed May 20, 2013, which claims the benefit of Japanese Patent Application No. 2012-129061, filed Jun. 6, 2012.

### BACKGROUND OF THE INVENTION

1. Field of the Invention

The present invention relates to a charging member, a process cartridge, and an electrophotographic apparatus.

2. Description of the Related Art

Currently, as one of the systems for charging the surface of an electrophotographic photosensitive member, there is given a contact charging system. The contact charging system involves applying a DC voltage or a voltage in which a DC voltage and an AC voltage are superimposed to a charging member arranged in contact with or close to a photosensitive member to cause minute discharge between the charging member and the photosensitive member, thereby charging the surface of the photosensitive member.

A configuration having a support and an electro-conductive elastic layer provided on the support is generally used as a configuration of a charging member to be used in the contact charging system from the viewpoint of sufficiently ensuring a nip between the charging member and the photosensitive member. Further, in order to suppress the adhesion of toner or the like to the surface of the charging member, a surface layer is also generally provided on the surface of the elastic layer.

Meanwhile, the applicant of the present application discloses in Japanese Patent Application Laid-Open No. 2011-154353 that a charging member including a surface layer containing titanium and polysiloxane formed on an elastic layer is excellent in charging ability for an electrophotographic photosensitive member and is capable of effectively preventing a low-molecular-weight component from bleeding from the elastic layer. Further, Japanese Patent Application Laid-Open No. 2011-154353 describes that a polysiloxane-containing film with high dielectric characteristics is formed through use of a hydrolyzable titanium compound, and as a result, the film can be used as a charging member enabling long-term stable charging and image output even when used in a DC contact charging system.

Further, Japanese Patent Application Laid-Open No. 2009-58635 discloses that, by incorporating polysiloxane having a predetermined structure and polyether-modified silicone oil or phenol-modified silicone oil into a surface layer, a charging member whose surface is less likely to be adhered to toner or an external additive is obtained.

### CITATION LIST

### Patent Literature

PTL 1: Japanese Patent Application Laid-Open No. 2011-154353
PTL 2: Japanese Patent Application Laid-Open No. 2009-58635

### SUMMARY OF THE INVENTION

However, as a result of the study by the inventors of the present invention, the following problem was found. That is, when the charging member in a static state according to Japanese Patent Application Laid-Open No. 2009-58635 was kept in contact with an electrophotographic photosensitive member for a long period of time, and thereafter, the charging member was used for forming an electrophotographic image, in the electrophotographic image, streak-like density unevenness due to a contact track between the charging member and the electrophotographic photosensitive member occurs in some cases.

It is known that, when a charging member having an elastic layer is kept in contact with another member for a long period of time, deformation which is not restored easily, that is, compression set occurs in the contact portion. It is also known that, because of the difference between the charging ability in a portion in which compression set of the charging member has occurred and the charging ability in a portion in which compression set of the charging member has not occurred, streak-like density unevenness sometimes occurs in an electrophotographic image based on the portion in which the compression set of the charging member has occurred.

However, the density unevenness which appeared in an electrophotographic image output through use of the charging member according to Japanese Patent Application Laid-Open No. 2009-58635 was particularly conspicuous. Then, the inventors of the present invention have assumed that silicone oil is involved in the density unevenness. That is, Japanese Patent Application Laid-Open No. 2009-58635 discloses that the charging ability of the charging member according to Japanese Patent Application Laid-Open No. 2009-58635 is enhanced by silicone oil added to the surface layer. Then, the inventors of the present invention have presumed that, in the contact portion between the charging member and another member, silicone oil in the surface layer was gone to the periphery of the contact portion owing to the contact pressure, and a large difference was caused in charging ability between the contact portion and the periphery thereof.

In view of the foregoing, the present invention is directed to providing a charging member whose surface is suppressed to adhesion of toner, a toner external additive, or the like, and which is less likely to occur a track due to the contact portion in an electrophotographic image even when the charging member is kept in contact with another member for a long period of time. Further, the present invention is directed to providing a process cartridge and an electrophotographic apparatus capable of stably providing high-quality electrophotographic images.

According to one aspect of the present invention, there is provided a charging member, comprising: a support; an elastic layer; and a surface layer, wherein the surface layer comprises: a constitutional unit represented by the following general formula (1); a constitutional unit represented by the following general formula (2); a polymer compound having a bond of Si—O—Ti; and at least one phenyl-modified silicone oil selected from the group consisting of phenyl-modified silicone oils represented by the following general formulae (7) to (10).

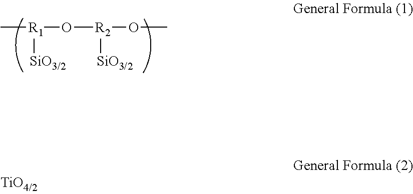

In the general formula (1), R₁ and R₂ each independently represent any of the following general formulae (3) to (6).

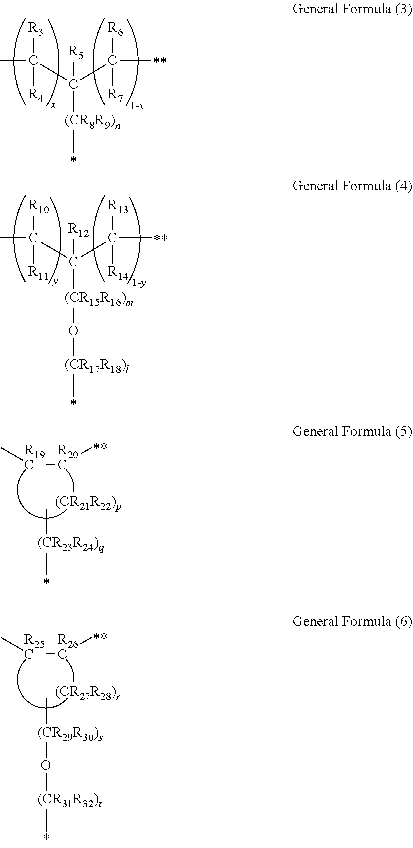

The R₃ to R₇, R₁₀ to R₁₄, R₁₉, R₂₀, R₂₅, and R₂₆ each independently represent a hydrogen atom, an alkyl group having 1 or more and 4 or less carbon atoms, a hydroxyl group, a carboxyl group, or an amino group. R₈, R₉, R₁₅ to R₁₈, R₂₃, R₂₄, and R₂₉ to R₃₂ each independently represent a hydrogen atom or an alkyl group having 1 or more and 4 or less carbon atoms. R₂₁, R₂₂, R₂₇, and R₂₈ each independently represent a hydrogen atom, an alkoxyl group having 1 or more and 4 or less carbon atoms, or an alkyl group having 1 or more and 4 or less carbon atoms. n, m, l, q, s, and t each independently represent an integer of 1 or more and 8 or less. p and r each independently represent an integer of 4 or more and 12 or less. x and y each independently represent 0 or 1. “*” and “**” represent sites to be bonded to a silicon atom and an oxygen atom in the general formula (1), respectively.

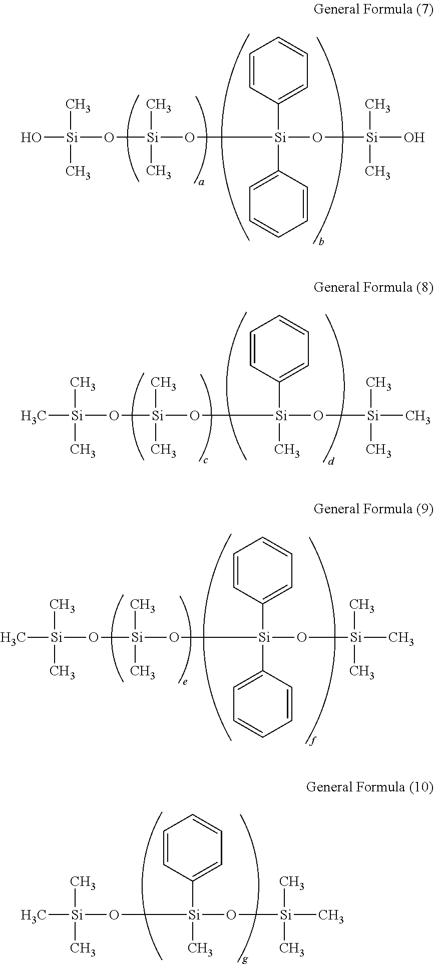

The a to f each independently represent an integer of 1 or more, and a+b, c+d, and e+f each independently represent an integer of 2 or more and 670 or less. g represents an integer of 1 or more and 20 or less.

According to another aspect of the present invention, there is provided an electrophotographic apparatus comprising an electrophotographic photosensitive member and the above-described charging member arranged in contact with the electrophotographic photosensitive member. According to further aspect of the present invention, there is provided a process cartridge comprising an electrophotographic photosensitive member and the above-described charging member arranged in contact with the electrophotographic photosensitive member, wherein the process cartridge is detachably mountable to a main body of an electrophotographic apparatus.

According to the present invention, there is provided the charging member whose surface is suppressed to adhesion of toner or an external additive and is not contaminated easily, and which is less likely to occur a track due to the contact between the charging member and a photosensitive member in an electrophotographic image. Further, according to the present invention, provided are the process cartridge and the electrophotographic apparatus capable of stably providing high-quality electrophotographic images.

Further features of the present invention will become apparent from the following description of exemplary embodiments with reference to the attached drawings.

### BRIEF DESCRIPTION OF THE DRAWINGS

FIG. 1 is a view illustrating an example of a charging member according to the present invention.

FIG. 2 is a sectional view of an electrophotographic apparatus according to the present invention.

FIG. 3 is a schematic view illustrating an example of a developing device.

FIG. 4 is a view illustrating a device for measuring a coefficient of kinetic friction.

FIG. 5 is a graph showing measurement result in ²⁹Si-NMR of a polymer compound according to the present invention.

FIG. 6 is a graph showing measurement result in ¹³C-NMR of the polymer compound according to the present invention.

FIG. 7 is an explanatory diagram of a crosslinking reaction in the step of forming a surface layer according to the present invention.

### DESCRIPTION OF THE EMBODIMENTS

Preferred embodiments of the present invention will now be described in detail in accordance with the accompanying drawings.

A charging member according to the present invention includes a support, an elastic layer formed on the support, and a surface layer formed on the elastic layer.

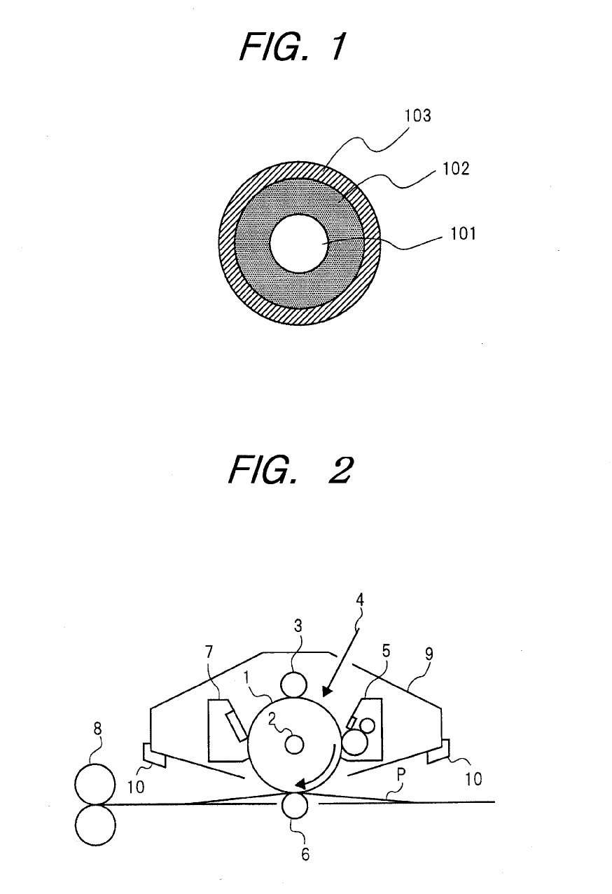

Although the simplest configuration of the charging member is a configuration in which two layers, i.e., the elastic layer and the surface layer are provided on the support, another layer or two or more other layers may be provided between the support and the elastic layer or between the elastic layer and the surface layer. In FIG. 1 illustrating a cross-section of a roller-shaped charging roller which is a typical example of the charging member, reference numerals 101, 102, and 103 denote the support, the elastic layer, and the surface layer, respectively.

<Support>

A support having electro-conductivity can be used as the support. Specific examples thereof include a support made of a metal (made of an alloy) such as iron, copper, stainless steel, aluminum, an aluminum alloy, or nickel.

<Elastic Layer>

One kind or two or more kinds of elastic bodies such as rubbers used in the elastic layers (electro-conductive elastic layers) of the conventional charging members can be used as the elastic layer. Examples of the rubbers include a urethane rubber, a silicone rubber, a butadiene rubber, an isoprene rubber, a chloroprene rubber, a styrene-butadiene rubber, an ethylene-propylene rubber, a polynorbornene rubber, a styrene-butadiene-styrene rubber, an acrylonitrile rubber, an epichlorohydrin rubber, and an alkyl ether rubber.

In addition, the electro-conductivity of the elastic layer can be set to a predetermined value by appropriately using an electro-conductive agent. The electrical resistance value of the elastic layer can be adjusted by appropriately selecting the kind and usage of the electro-conductive agent, and the electrical resistance value falls within the range of suitably 10² to 10⁸Ω, more suitably 10³ to 10⁶Ω. In addition, electro-conductive carbons such as ketjen black EC, acetylene black, carbon for rubber, oxidized carbon for coloring (ink), and pyrolytic carbon may each be used as the electro-conductive agent for the elastic layer. In addition, graphites such as natural graphite and artificial graphite may each be used as the electro-conductive agent for the elastic layer. An inorganic or organic filler, or a crosslinking agent may be added to the elastic layer.

The hardness of the elastic layer is preferably 60° or more and 85° or less, particularly preferably 70° or more and 80° or less in terms of MD-1 hardness from the viewpoint of the suppression of the deformation of the charging member when the charging member and a photosensitive member as a body to be charged are brought into contact with each other.

As a guideline, the surface roughness (Rz) of the elastic layer is preferably 3.0 μm or more and 12.0 μm or less, particularly preferably, 5.0 or more and 10.0 μm or less.

The elastic layer is formed on the support by mixing the above-mentioned materials for the electro-conductive elastic body with a hermetic mixer or the like and subjecting the mixture to a known method such as extrusion molding, injection molding, or compression molding. It should be noted that the elastic layer is adhered onto the support through the intermediation of an adhesive as necessary. The elastic layer formed on the support is vulcanized as necessary. When the vulcanization temperature is raised rapidly, a volatile by-product such as a vulcanization accelerator is gasified owing to the vulcanization reaction to cause voids. Therefore, it is preferred to divide a heating zone into two zones and perform vulcanization in a second zone after sufficiently removing a gas component by holding the first zone in a state lower than the vulcanization temperature.

<Surface Layer>

The surface layer forming the charging member according to the present invention contains a polymer compound having a particular constitutional unit and phenyl-modified silicone oil having a particular structure.

(Polymer Compound)

That is, the polymer compound according to the present invention has a constitutional unit represented by the following general formula (1), a constitutional unit represented by the following general formula (2), and an Si—O—Ti bond. It should be noted that, that the polymer compound has an Si—O—Ti bond in a molecular structure means the bond of Si and Ti at a molecular level. A surface layer containing such polymer compound tends to become a uniform coat without phase separation and becomes a surface layer having charging uniformity when used in a charging member. When the polymer compound has the constitutional unit represented by the general formula (1), the adhesiveness of the surface layer with respect to the elastic layer is enhanced. When the polymer compound has the constitutional unit represented by the general formula (2), the enhancement of charging ability can be expected. It should be noted that TiO_{4/2} means that Ti is in a state of having four bonds with respect to other atoms (Si, Ti) through 0.

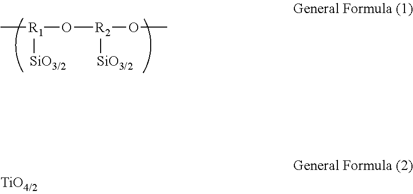

[In the general formula (1), R₁ and R₂ each independently represent any of the following general formulae (3) to (6).

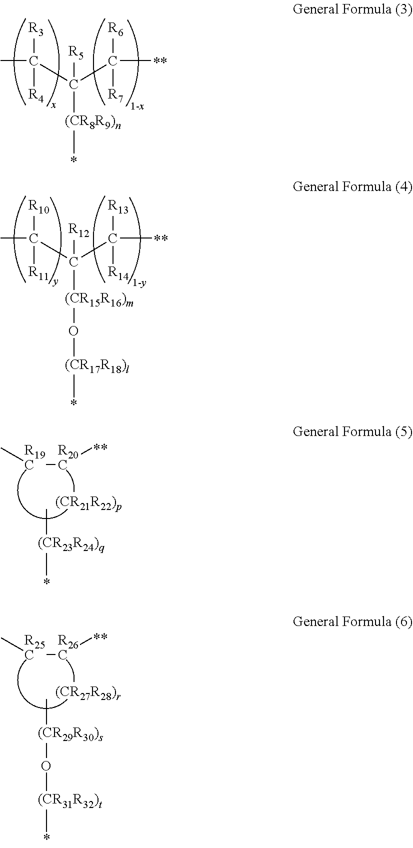

The R₃ to R₇, R₁₀ to R₁₄, R₁₉, R₂₀, R₂₅, and R₂₆ each independently represent a hydrogen atom, an alkyl group having 1 or more and 4 or less carbon atoms, a hydroxyl group, a carboxyl group, or an amino group. R₈, R₉, R₁₅ to R₁₈, R₂₃, R₂₄, and R₂₉ to R₃₂ each independently represent a hydrogen atom, or an alkyl group having 1 or more and 4 or less carbon atoms. R₂₁, R₂₂, R₂₇, and R₂₈ each independently represent a hydrogen atom, an alkoxyl group having 1 or more and 4 or less carbon atoms, or an alkyl group having 1 or more and 4 or less carbon atoms. n, m, l, q, s, and t each independently represent an integer of 1 or more and 8 or less. p and r each independently represent an integer of 4 or more and 12 or less. x and y each independently represent 0 or 1. “*” and “**” represent sites to be bonded to a silicon atom and an oxygen atom in the general formula (1), respectively.

It is preferred that R₁ and R₂ in the general formula (1) of the polymer compound each independently represent any of the following general formulae (11) to (14). In this case, the presence of an organic chain enables the control of the elastic modulus of the surface layer, or the brittleness and flexibility as film characteristics of the surface layer. Further, when the structure of the organic chain, in particular, an ether moiety is present, the adhesiveness of the surface layer with respect to the elastic layer is enhanced.

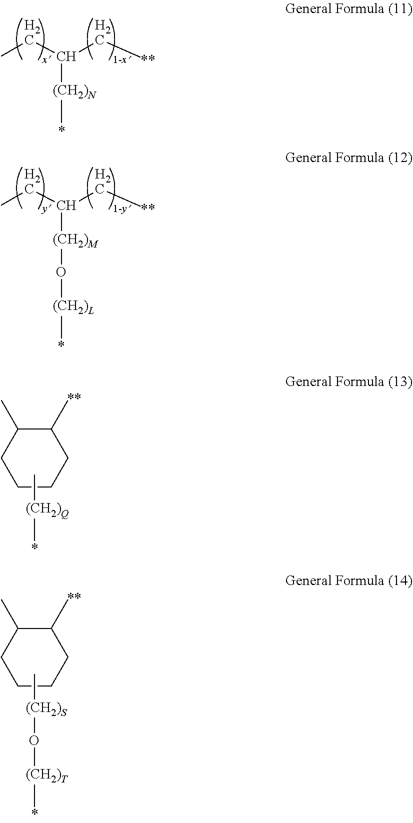

Here, N, M, L, Q, S, and T each independently represent an integer of 1 or more and 8 or less, x′ and y′ each independently represent 0 or 1, and “*” and “**” represent sites to be bonded to a silicon atom and an oxygen atom in the general formula (1), respectively.

It is preferred that an atomic ratio Ti/Si between titanium and silicon in the polymer compound be 0.1 or more and 12.5 or less. From the viewpoint of enhancing the charging ability of the charging member, this value is preferably 0.1 or more, more preferably 0.5 or more. Further, from the viewpoint of enhancing the coatability and storability of a mixed solution, this value is preferably 12.5 or less, more preferably 10.0 or less.

It is preferred that the polymer compound be a hydrolyzed condensate of hydrolysable compounds respectively represented by the following general formulae (15) and (16). By controlling the degree of hydrolysis and condensation caused by a trifunctional moiety in the general formula (15) and a tetrafunctional moiety in the general formula (16), the elastic modulus and denseness of the surface layer can be controlled.

Further, by using an organic chain moiety of R₃₃ in the general formula (15) as a curing site, the toughness of the surface layer and the adhesiveness of the surface layer with respect to the elastic layer can be controlled. Further, by setting R₃₃ to be an organic group having an epoxy group which is subjected to ring-opening by irradiation with ultraviolet rays, the curing time can be shortened and the heat deterioration of the elastic layer can be suppressed compared with a conventional thermosetting material.

R₃₃—Si(OR₃₄)(OR₃₅)(OR₃₆) General Formula (15)

Ti(OR₃₇)(OR₃₈)(OR₃₉)(OR₄₀) General Formula (16)

In the general formula (15), R₃₃ represents any one of the following general formulae (17) to (20) each having an epoxy group, and R₃₄ to R₃₆ each independently represent an alkyl group having 1 or more and 4 or less carbon atoms. In addition, in the general formula (16), R₃₇ to R₄₀ each independently represent an alkyl group having 1 or more and 9 or less carbon atoms.

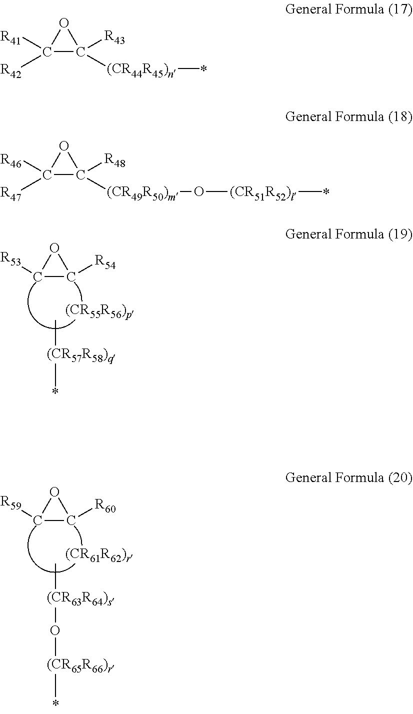

In the general formulae (17) to (20), R₄₁ to R₄₃, R₄₆ to R₄₈, R₅₃, R₅₄, R₅₉, and R₆₀ each independently represent a hydrogen atom, an alkyl group having 1 or more and 4 or less carbon atoms, a hydroxyl group, a carboxyl group, or an amino group; R₄₄, R₄₅, R₄₉ to R₅₂, R₅₇, R₅₈, and R₆₃ to R₆₆ each independently represent a hydrogen atom, or an alkyl group having 1 or more and 4 or less carbon atoms; R₅₅, R₅₆, R₆₁, and R₆₂ each independently represent a hydrogen atom, an alkoxyl group having 1 or more and 4 or less carbon atoms, or an alkyl group having 1 or more and 4 or less carbon atoms; n′, m′, l′, q′, s′, and t′ each independently represent an integer of 1 or more and 8 or less; p′ and r′ each independently represent an integer of 4 or more and 12 or less; and “*” represents a site to be bonded to a silicon atom in the general formula (15).

Examples of the hydrocarbon groups represented by R₃₄ to R₃₆ in the general formula (15) include an alkyl group, an alkenyl group, and an aryl group. Of those, a linear or branched alkyl group having 1 to 4 carbon atoms is preferred, and a methyl group, an ethyl group, an n-propyl group, an i-propyl group, an n-butyl group, or a t-butyl group is more preferred.

A hydrolyzable silane compound having a structure represented by the general formula (15) is specifically exemplified below: 4-(1,2-epoxybutyl)trimethoxysilane, 5,6-epoxyhexyltriethoxysilane, 8-oxirane-2-yloctyltrimethoxysilane, 8-oxirane-2-yloctyltriethoxysilane, 3-glycidoxypropyltrimethoxysilane, 3-glycidoxypropyltriethoxysilane, 1-(3,4-epoxycyclohexyl)ethyltrimethoxysilane, 1-(3,4-epoxycyclohexyl)ethyltriethoxysilane, 3-(3,4-epoxycyclohexyl) methyloxypropyltrimethoxysilane, and 3-(3,4-epoxycyclohexyl)methyloxypropyltriethoxysilane.

The hydrocarbon groups represented by R₃₇ to R₄₀ in the general formula (16) are each preferably represent a hydrocarbon group having 1 or more and 18 or less carbon atoms from the viewpoint of a reaction rate.

A hydrolyzable titanium compound having a structure represented by the general formula (16) is specifically exemplified below: titanium methoxide, titanium ethoxide, titanium n-propoxide, titanium i-propoxide, titanium n-butoxide, titanium t-butoxide, titanium i-butoxide, titanium nonyloxide, titanium 2-ethylhexoxide, and titanium methoxypropoxide.

A hydrolyzable silane compound having a structure represented by the general formula (17) is specifically exemplified below: 4-(1,2-epoxybutyl)trimethoxysilane, 4-(1,2-epoxybutyl)triethoxysilane, 5,6-epoxyhexyltrimethoxysilane, 5,6-epoxyhexyltriethoxysilane, 8-oxirane-2-yloctyltrimethoxysilane, and 8-oxirane-2-yloctyltriethoxysilane.

A hydrolyzable silane compound having a structure represented by the general formula (18) is specifically exemplified below: glycidoxypropyltrimethoxysilane and glycidoxypropyltriethoxysilane.

A hydrolyzable silane compound having a structure represented by the general formula (19) is specifically exemplified below: 2-(3,4-epoxycyclohexyl)ethyltrimethoxysilane and 2-(3,4-epoxycyclohexyl)ethyltriethoxysilane.

A hydrolyzable silane compound having a structure represented by the general formula (20) is specifically exemplified below: 3-(3,4-epoxycyclohexyl)methyloxypropyltrimethoxysilane and 3-(3,4-epoxycyclohexyl) methyloxypropyltriethoxysilane.

Further, it is preferred that the polymer compound in the present invention include a crosslinked product of the hydrolyzable compounds represented by the general formulae (15) and (16) and a hydrolyzable compound represented by the following general formula (21). In this case, the solubility of the compounds of the general formulae (15) and (16) in a synthesis stage, coatability, and further the electric characteristics as physical properties of a film after being cured can be enhanced. It is particularly preferred that R₆₇ be an alkyl group because the solubility and coatability are improved. Further, it is preferred that R₆₇ be a phenyl group because this case contributes to the enhancement of the electric characteristics, in particular, the volume resistivity.

R₆₇—Si(OR₆₈)(OR₆₉)(OR₇₀) General Formula (21)

In the general formula (21), R₆₇ represents an alkyl group or a phenyl group. As the alkyl group, a linear alkyl group having 1 to 21 carbon atoms is preferred, and a linear alkyl group having 6 to 10 carbon atoms is more preferred. R₆₈ to R₇₀ each independently represent an alkyl group having 1 to 4 carbon atoms.

A hydrolyzable silane compound having a structure represented by the general formula (21) is specifically exemplified below: methyltrimethoxysilane, methyltriethoxysilane, methyltripropoxysilane, ethyltrimethoxysilane, ethyltriethoxysilane, ethyltripropoxysilane, propyltrimethoxysilane, propyltriethoxysilane, propyltripropoxysilane, hexyltrimethoxysilane, hexyltriethoxysilane, hexyltripropoxysilane, decyltrimethoxysilane, decyltriethoxysilane, decyltripropoxysilane, phenyltrimethoxysilane, phenyltriethoxysilane, and phenyltripropoxysilane.

When the hydrolyzable silane compound having a structure represented by the general formula (21) is used in combination, a hydrolyzable silane compound in which R₆₇ represents a linear alkyl group having 6 to 10 carbon atoms and a hydrolyzable silane compound in which R₆₇ represents a phenyl group are preferably combined. In this case, compatibility with a solvent is good even when a monomer structure changes owing to a hydrolysis and condensation reaction.

<Phenyl-Modified Silicone Oil>

The surface layer according to the present invention contains at least one phenyl-modified silicone oil (hereinafter sometimes simply referred to as “silicone oil”) selected from the group consisting of phenyl-modified silicone oils having structures represented by the following general formulae (7) to (10), together with the above-mentioned polymer compound.

Then, even in the case where those silicone oils are contained in the surface layer of the charging member, those silicone oils do not greatly change the charging ability of the charging member. Therefore, even in the case where compression set occurs in part of the charging member owing to the long-term contact between the charging member and the photosensitive member, and silicone oil is present disproportionately around the portion in which the compression set occurs, a difference in charging ability is less likely to occur between the portion in which the compression set occurs and any other portion.

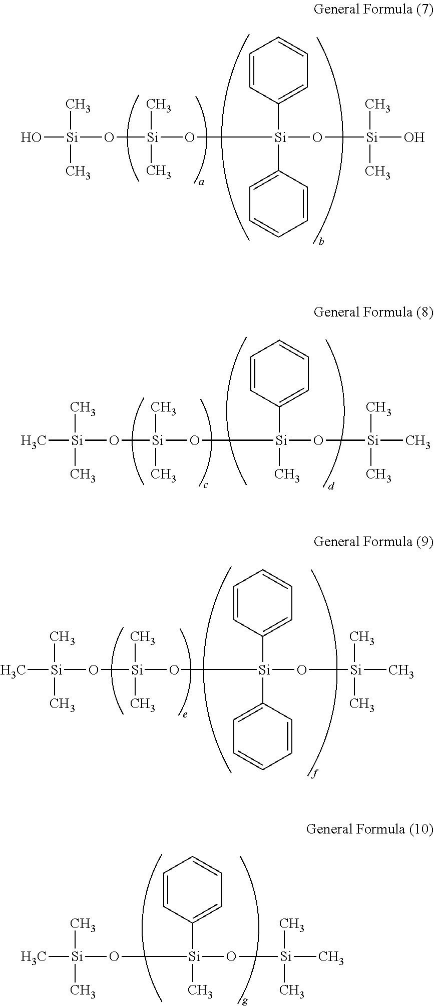

In the general formulae (7) to (10), a to f each independently represent an integer of 1 or more, and a+b, c+d, and e+f each independently represent an integer of 2 or more and 670 or less. g represents an integer of 1 or more and 20 or less.

Phenyl-modified silicone oils can be classified into three kinds, i.e., a diphenyl-dimethyl type, a phenylmethyl-dimethyl type, and a phenyl-methyl type based on the bonding position of an organic chain containing a phenyl group, and further classified into a terminal-modified type and a terminal-unmodified type. Of those, from the viewpoint of suppressing the adhesion of toner, a toner external additive, or the like to the charging member, those containing dimethyl are preferred, and those containing diphenyl, which exhibits a suppressing effect on an increase in surface potential of the photosensitive member, are preferred. It should be noted that the silicone oil represented by the general formula (7) is of a terminal silanol-modified diphenyl-dimethyl type. The silicone oil represented by the general formula (8) is of a terminal-unmodified phenylmethyl-dimethyl type. The silicone oil represented by the general formula (9) is of a terminal-unmodified diphenyl-dimethyl type. Further, the silicone oil represented by the general formula (10) is of a terminal-unmodified phenyl-methyl type.

Specific examples of the phenyl-modified silicone oil having a structure represented by the general formula (7) include PDS-1615 (trade name, viscosity: 50 to 60, manufactured by Gelest) and PDS-0338 (trade name, viscosity: 6,000 to 8,000, manufactured by Gelest).

Specific examples of the phenyl-modified silicone oil having a structure represented by the general formula (8) include SH510-100CS (trade name, viscosity: 100, manufactured by Dow Corning Toray Co., Ltd.), and SH510-500CS (trade name, viscosity: 500, manufactured by Dow Corning Toray Co., Ltd.).

Specific examples of the phenyl-modified silicone oil having a structure represented by the general formula (9) include KF50-100CS (trade name, viscosity: 100, manufactured by Shin-Etsu Chemical Co., Ltd.), and KF50-1000CS (trade name, viscosity: 1,000, manufactured by Shin-Etsu Chemical Co., Ltd.).

Specific examples of the phenyl-modified silicone oil having a structure represented by the general formula (10) include PMM-0011 (trade name, viscosity: 10 to 20, manufactured by Gelest, Inc.) and PMM-0025 (trade name, viscosity: 500, manufactured by Gelest, Inc.).

It is preferred that a mass-average molecular weight Mw of the silicone oil be 100 or more and 50,000 or less. It is preferred that the mass-average molecular weight Mw be 100 or more because a decreasing effect on surface free energy increases. It is preferred that the mass-average molecular weight Mw be 50,000 or less because the affinity of the silicone oil with respect to a surface-layer coating liquid increases and hence opacification causing coating unevenness is less likely to occur. The mass-average molecular weight is more preferably 300 or more.

It should be noted that, for measuring the mass-average molecular weight of the silicone oil, HLC-8120GPC (trade name, manufactured by Tosoh Corporation) can be used as a GPC device. Five columns, i.e., “TSK guardcolum SuperH-L (trade name),” “TSKgel SuperH4000 (trade name),” “TSKgel SuperH3000 (trade name),” “TSKgel SuperH2000 (trade name),” and “TSKgel SuperH1000 (trade name)” can be connected to be used. Toluene for high-performance liquid chromatography can be used as an eluent. The temperature can be set as follows: INLET: 40° C., OVEN: 40° C., and RI: 40° C. Detection can be performed with an RI detector, and polystyrene (EasiCal PS-2) can be used for a calibration curve.

The surface free energy of the charging member is preferably 30 mJ/m² or less. When the surface free energy is 30 mJ/m² or less, the affinity of the charging member with respect to an adhering matter such as toner or a toner external additive is low, and hence the adhering matter becomes less likely to be fixed to the charging member even when the adhering matter is present in the vicinity of the surface of the charging member. The surface free energy can be measured through use of a contact angle meter CA-X RALL type manufactured by Kyowa Interface Science Co., LTD. Further, for analysis of the surface free energy, Kitazaki/Hata theory can be used, and the surface free energy (γ^{total}) can be calculated by the following expression:

γ^{total}=γ^{d}+γ^{p}+γ^{h}

where γ^{d} represents a component of a dispersion term, γ^{p} represents a component of a polar term, γ^{h} represents a component of a hydrogen bond term, and γ^{total} represents the sum of the respective components.

The coefficient of kinetic friction of the surface layer of the charging member is preferably 0.1 or more and 0.4 or less in measurement with respect to a polyethylene terephthalate (PET) sheet. When the coefficient of kinetic friction is 0.1 or more, the driven state of the charging member with respect to the photosensitive member is satisfactory, and the slipping of the charging member can be easily prevented, whereby the charging member can charge the photosensitive member stably. Further, when the coefficient of kinetic friction is 0.4 or less, the adhesion of toner or the like to the charging member is particularly less, and charging defects can be prevented easily.

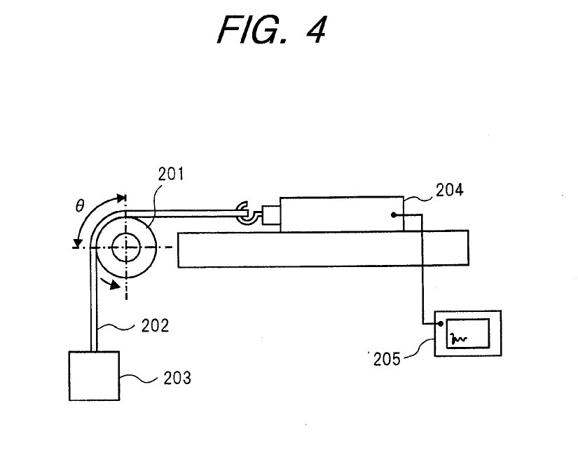

FIG. 4 illustrates a measurement device of a coefficient of kinetic friction. In FIG. 4, a charging member 201 to be measured is in contact with a belt 202 at a predetermined angle θ. A weight 203 is connected to one end of the belt 202, and a load meter 204 is connected to the other end. Further, a recorder 205 is connected to the load meter 204. It should be noted that, in examples to be described later, a PET belt having a thickness of 100 μm, a width of 30 mm, and a length of 180 mm (trade name: Lumirror S10 #100, manufactured by Toray Industries, Inc.) is used as the belt.

Assuming that a force measured by the load meter 204 is F [N] and the total weight of the weight and the belt is W [N] when the charging member 201 is rotated at a predetermined speed in a predetermined direction in the state illustrated in FIG. 4, the coefficient of friction is determined by the following expression. It should be noted that the measurement method is based on Euler's belt formula.

Coefficient of friction=(1/θ)ln(F/W)

In the examples to be described later, measurement is conducted with W being 0.98 [N] (weight: 100 g), a rotation speed of the charging member being 115 rpm, and the measurement environment being 23° C., and the relative humidity being 50%.

In addition, a cationic polymerization catalyst as a photopolymerization initiator is preferably caused to coexist from the viewpoint of an improvement in crosslinking efficiency during the crosslinking reaction. For example, an epoxy group shows high reactivity for an onium salt of a Lewis acid activated with an active energy ray. Accordingly, when the cationically polymerizable group is an epoxy group, the onium salt of the Lewis acid is preferably used as the cationic polymerization catalyst.

Other examples of the cationic polymerization catalyst include a borate, a compound having an imide structure, a compound having a triazine structure, an azo compound, and a peroxide. Of various kinds of cationic polymerization catalysts, an aromatic sulfonium salt and an aromatic iodonium salt are preferred from the viewpoints of sensitivity, stability, and reactivity. A bis(4-tert-butylphenyl)iodonium salt, a compound having a structure represented by the following chemical formula (22) (trade name: Adekaoptomer SP150, manufactured by ADEKA CORPORATION), or a compound having a structure represented by the following chemical formula (23) (trade name: IRGACURE 261, manufactured by Ciba Specialty Chemicals Inc.) is particularly preferred.

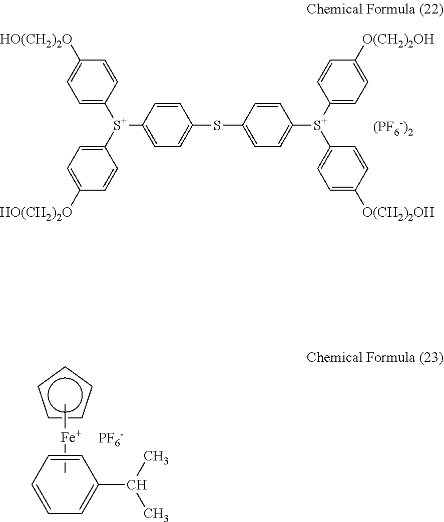

In addition, the cationic polymerization catalyst as a photopolymerization initiator is preferably added in an amount of 1.0 to 3.0 parts by mass with respect to 100 parts by mass of the hydrolyzed condensate. As long as the addition amount falls within the range, curing characteristics and the solubility of the photopolymerization initiator are good.

The charging member according to the present invention is obtained by forming a coat of a paint containing the above-mentioned hydrolyzed condensate and phenyl-modified silicone oil on an outer circumference of the elastic layer, and crosslinking the hydrolyzed condensate in the coat to form the polymer compound.

<Method of Producing Charging Member>

Hereinafter, the method of producing the charging member of the present invention is exemplified. “Production Method Example 1” is a method of producing the charging member with the compounds represented by the general formulae (15) and (16), and any one of the phenyl-modified silicone oils represented by the general formulae (7) to (10). In addition, a “Production Method Example 2” is a method of producing the charging member with the compounds represented by the general formulae (15), (16), and (21), and any one of the phenyl-modified silicone oils represented by the general formulae (7) to (10).

Production Method Example 1 includes the following first step (i) and second step (ii).

(i) First step involving forming, on the elastic layer arranged on the outer circumference of the support, a coat of a paint for forming a surface layer containing a hydrolyzed condensate of the hydrolyzable compound having the structure represented by the general formula (15) and the hydrolyzable compound having the structure represented by the general formula (16), and one or more phenyl-modified silicone oils selected from the group consisting of the phenyl-modified silicone oils represented by the general formulae (7) to (10).

(ii) Second step involving producing the polymer compound by cleaving an epoxy group of R₃₃ of the hydrolyzed condensate in the coat to crosslink the hydrolyzed condensate.

In the case of Production Method Example 2, a mixture of the hydrolyzable compounds of the general formulae (15) and (21) is used instead of the hydrolyzable compound of the general formula (15) in the step (i).

Performed in the step (i) is the step (iii) (first stage reaction) involving performing hydrolysis and condensation by adding water and alcohol to a hydrolyzable silane compound followed by reflux under heating. Further, the step (iv) (second stage reaction) involving performing hydrolysis and condensation by adding the hydrolyzable compound having the structure represented by the general formula (16) to the hydrolyzed and condensed solution obtained in the step (iii) is performed.

Next, it is preferred to perform the step (ii) after performing the step (v) involving adding one or at least two phenyl-modified silicone oils selected from the group consisting of the phenyl-modified silicone oils represented by the general formulae (7) to (10) and the photopolymerization initiator to the solution obtained in the step (iv).

It is because of the following reason that the two-stage synthesis reaction of the steps (iii) and (iv) is performed as described above. The reaction rate of the hydrolyzable compound represented by the general formula (15) or the reaction rate of the combination of the hydrolyzable compounds represented by the general formula (15) and the general formula (21), and the reaction rate of the hydrolyzable compound represented by the general formula (16) are extremely different from each other, in other words, the reaction rate of the compound represented by the general formula (16) is extremely high. As long as the Ti/Si ratio is about 0.10 to 0.30 (region where the concentration of Ti is small), the hydrolysis and condensation reaction smoothly progresses even when the reaction is not divided into two stages. However, when the Ti/Si ratio is about 0.30 to 12.50 (region where the concentration of Ti is large), only the hydrolyzable compound represented by the general formula (16) selectively reacts owing to the difference in reaction rate, and hence opacification and precipitation are liable to occur.

Further, it is preferred that a ratio WR (molar ratio) of an amount to be added of water to a hydrolyzable silane compound at the time of synthesis of a hydrolyzed condensate be 0.3 or more and 6.0 or less.

WR=water/{hydrolyzable compound(15)+hydrolyzable compound (21)}

It is preferred that the value of the WR be 1.2 or more and 3.0 or less. When the amount to be added of the water is in the above-mentioned range, the degree of condensation during synthesis can be controlled easily. Further, the condensation speed can also be controlled easily, and it is also effective for the stability of the lives of: the mixed solution of the hydrolyzed condensate and the phenyl-modified silicone oil; and the coating liquid for forming a surface layer. Further, it is preferred that the amount to be added of the water be in the above-mentioned range because the hydrolyzed condensate can be synthesized in a pH region where the epoxy group in the general formula (15) is not subjected to ring-opening.

In addition, a primary alcohol alone, a mixture of a primary alcohol and a secondary alcohol, or a mixture of a primary alcohol and a tertiary alcohol is preferably used as an alcohol upon synthesis of the hydrolyzed condensate. Ethanol alone, a mixture of methanol and 2-butanol, or a mixture of ethanol and 2-butanol is particularly preferred.

It is preferred that the usage of the phenyl-modified silicone oil be 1.0 part by mass or more and 30 parts by mass or less with respect to 100 parts by mass of: the hydrolyzed condensate of the hydrolyzable compounds of the general formula (15) and the general formula (16); or the hydrolyzed condensate of a combination of the hydrolyzable compounds of the general formula (15) and the general formula (21) and the hydrolyzable compound of the general formula (16). It is preferred that the usage of the phenyl-modified silicone oil be 1.0 part by mass or more because the surface free energy decreases easily, which is effective for adjusting the affinity of the charging member with respect to an adhering matter. It is preferred that the usage of the phenyl-modified silicone oil be 30 parts by mass or less from the viewpoint of maintaining charging characteristics.

Further, in order to enhance its compatibility with the mixed solution, the photopolymerization initiator can be diluted with a solvent such as alcohol or ketone in advance. As the solvent to be used for dilution, for example, there are given methanol, acetone, methyl ethyl ketone (MEK), and methyl isobutyl ketone (MIBK).

Next, a paint for forming a surface layer is obtained by adjusting the concentration of the obtained mixed solution containing the hydrolyzed condensate and the phenyl-modified silicone oil to an appropriate value. The paint for forming a surface layer is applied onto a member having a support and an elastic layer formed on the support.

When the paint for forming a surface layer is prepared, an appropriate solvent considering volatility may be used besides the solvent used for synthesis of the hydrolyzed condensate so as to enhance coatability. Examples of the appropriate solvent include 2-butanol, ethyl acetate, methyl ethyl ketone, and a mixture thereof. The concentration of the paint for forming a surface layer is preferably 0.05 mass % or more from the viewpoints of decreasing the surface free energy and suppressing an increase in surface potential of the photosensitive member, and is preferably 4.0 mass % or less from the viewpoint of suppressing coating unevenness.

In addition, upon coat of the paint for forming a surface layer onto the elastic layer, application with a roll coater, dip coating, ring application, or the like can be adopted.

Next, a cationically polymerizable group of the hydrolyzed condensate in the coat of the paint for forming a surface layer formed on the elastic layer is cleaved by irradiating the coat with active energy rays. Thus, the molecules of the hydrolyzed condensate in the coat are crosslinked with each other to form the surface layer. Ultraviolet rays are preferably used as the active energy rays. By curing the surface layer with ultraviolet rays, excess heat is less likely to be generated, and phase separation due to volatilization of a solvent such as thermosetting is less likely to occur, whereby a uniform coat state is obtained. Therefore, a uniform and stable potential can be given to the photosensitive member. Further, the elastic layer can be prevented from being degraded by thermal history if the crosslinking reaction is performed with ultraviolet rays, and hence the electric characteristics of the elastic layer can also be prevented from being degraded.

For the irradiation of the ultraviolet rays, a high-pressure mercury lamp, a metal halide lamp, a low-pressure mercury lamp, an excimer UV lamp, or the like can be used. Of those, an UV light source rich in ultraviolet rays each having a wavelength of 150 to 480 nm is preferably used. It should be noted that the cumulative light quantity of the ultraviolet rays is defined as described below.

Cumulative light quantity of ultraviolet ray [mJ/cm²]=ultraviolet rays intensity [mW/cm²]×irradiation time[s]

The cumulative light quantity of the ultraviolet rays can be adjusted depending on the irradiation time, a lamp output, and a distance between the lamp and a body to be irradiated. In addition, the cumulative light quantity may be provided with a gradient within the irradiation time.

When a low-pressure mercury lamp is used, the cumulative light quantity of the ultraviolet rays can be measured with a UV cumulative actinometer “UIT-150-A” or “UVD-S254” manufactured by USHIO INC. When an excimer UV lamp is used, the cumulative light quantity of the ultraviolet rays can be measured with a UV cumulative actinometer “UIT-150-A” or “VUV-S172” manufactured by USHIO INC.

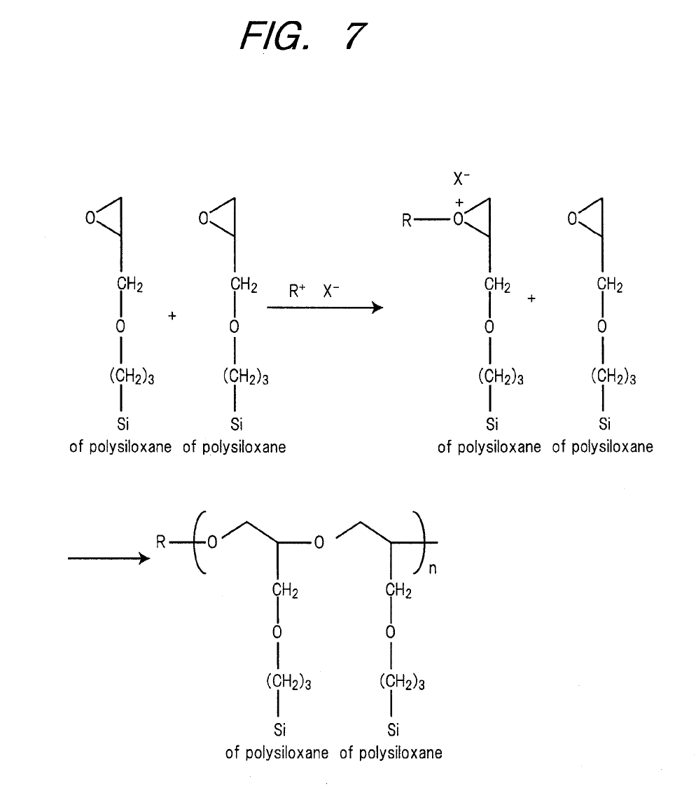

FIG. 7 shows a specific example of crosslinking and curing reactions. That is, a hydrolyzed condensate produced by using 3-glycidoxypropyl trimethoxysilane as the compound represented by the general formula (15) and the compounds represented by the general formulae (21) and (16) has an epoxy group (glycidoxypropyl group) as a cationically polymerizable group. The epoxy group of such hydrolyzed condensate is subjected to ring-opening in the presence of a cation polymerization catalyst (described as R⁺X⁻ in FIG. 7), and polymerization proceeds in a chain-reaction manner. As a result, polysiloxanes each containing TiO_{4/2} and SiO_{3/2} are crosslinked to be cured, and thus the surface layer according to the present invention is formed. It should be noted that n represents an integer of 1 or more in FIG. 7.

As a guideline of the thickness of the surface layer, it is preferred that the thickness be 10 to 400 nm, in particular, 50 to 350 nm from the viewpoints of the charging ability, the suppression of bleed-out of a low-molecular-weight component from the elastic layer in the case of the presence of the elastic layer, and the like.

<Electrophotographic Apparatus and Process Cartridge>

FIG. 2 is an example of the schematic construction of an electrophotographic apparatus including a process cartridge having the charging member of the present invention. The electrophotographic apparatus has a cylindrical photosensitive member 1 to be rotationally driven around an axis 2 in the direction indicated by an arrow at a predetermined circumferential speed. The photosensitive member may have a support, a photosensitive layer, a charge-injection layer, a surface layer, and the like formed on the support.

The surface of the photosensitive member to be rotationally driven is uniformly charged to a positive or negative predetermined potential by a charging member 3. Next, the surface receives exposure light (image exposure light) 4 output from exposing device (not shown) such as slit exposure or laser beam scanning exposure so that electrostatic latent images corresponding to a target image may be formed.

Upon charging of the surface of the photosensitive member 1 by the charging member 3, a DC voltage or a voltage obtained by superimposing an AC voltage on a DC voltage is applied to the charging member 3 from voltage-applying device (not shown).

The electrostatic latent images formed on the surface of the photosensitive member 1 are each supplied with a developer from a developing roller provided for developing device 5, and are then subjected to reversal development or regular development to turn into toner images. Next, the toner images on the surface of the photosensitive member 1 are sequentially transferred by a transfer bias applied to a transfer roller 6 onto a transfer material P such as paper conveyed to a gap between the photosensitive member 1 and the transfer roller 6 in synchronization with the rotation of the photosensitive member.

As developing device, for example, there may be given jumping development device, contact development device, and magnetic brush device. Further, one having an elastic layer adjusted to intermediate resistance on the support can be used as the transfer roller.

The transfer material P onto which the toner images have been transferred is separated from the surface of the photosensitive member 1 to be introduced into fixing device 8, and is then printed out as an image-formed product (print or copy) onto which the toner images have been fixed to the outside of the apparatus. In the case of a double image formation mode or a multiple image formation mode, the image-formed product is introduced into a recirculation conveying mechanism, and is then reintroduced into a transfer portion.

A transfer residual developer (toner) on the surface of the photosensitive member 1 after the transfer of the toner images is removed by cleaning device 7 such as a cleaning blade so that the surface may be cleaned. Further, the surface is subjected to a discharging treatment by pre-exposure light from pre-exposing device, and is then repeatedly used for image formation. When the charging device is contact charging device, the pre-exposure is not necessarily needed.

The photosensitive member 1, the charging member 3, the developing device 5, and the cleaning device 7 are integrated to form a process cartridge 9. The process cartridge 9 is detachably mountable to the main body of the electrophotographic apparatus with guiding device 10 such as a rail of the main body of the electrophotographic apparatus. A cartridge formed of device appropriately selected from transferring device and the like in addition to the above-mentioned members can also be detachably mountable to the main body of the electrophotographic apparatus.

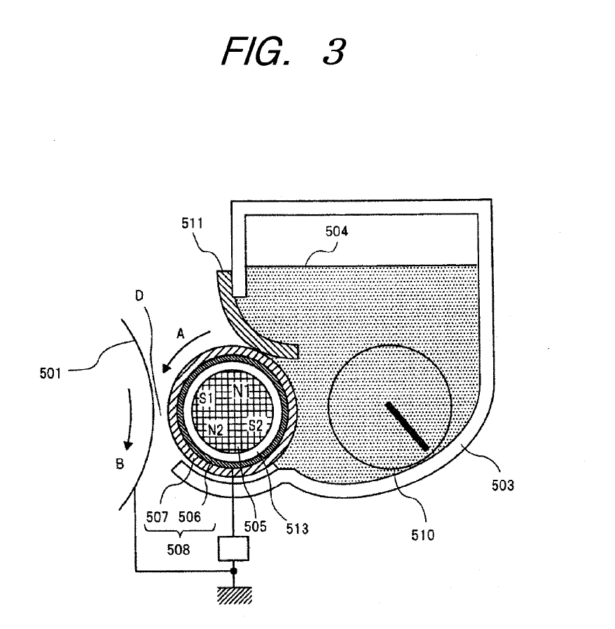

In addition, FIG. 3 illustrates a schematic sectional view of the developing unit of the above-mentioned developing device 5. In FIG. 3, an electrophotographic photosensitive drum 501 as a bearing member for bearing an electrostatic latent image formed by a known process is rotated in the direction indicated by an arrow B. A developing sleeve 508 as a developer carrying member is rotated in the direction indicated by an arrow A while carrying a one-component developer 504 containing a magnetic toner supplied from a hopper 503 as a developer container. Thus, the developer 504 is conveyed to a developing region D where the developing sleeve 508 and the photosensitive drum 501 are opposed to each other. As illustrated in FIG. 3, a magnet roller 505 having magnets provided therein is placed in the developing sleeve 508 in order that the developer 504 may be magnetically attracted and held on the developing sleeve 508.

The developing sleeve 508 to be used in the developing unit of the present invention has a metal cylindrical tube 506 as a support and an electro-conductive resin coating layer 507 that coats the top of the tube. A stirring blade 510 for stirring the developer 504 is provided in the hopper 503. Reference numeral 513 represents a gap showing that the developing sleeve 508 and the magnet roller 505 are in a non-contact state. The developer 504 obtains triboelectric charge with which an electrostatic latent image on the photosensitive drum 501 can be developed as a result of mutual friction between magnetic toner particles for forming the developer and friction with the electro-conductive resin coating layer 507 on the developing sleeve 508. In the example of FIG. 3, a magnetic regulating blade 511 made of a ferromagnetic metal as a developer thickness-regulating member is provided for regulating the thickness of the developer 504 to be conveyed to the developing region D. The magnetic regulating blade 511 is hung down from the hopper 503 so as to border the developing sleeve 508 with a gap width of about 50 to 500 μm from the surface of the developing sleeve 508. The convergence of lines of magnetic force from a magnetic pole N1 of the magnet roller 505 on the magnetic regulating blade 511 results in the formation of a thin layer of the developer 504 on the developing sleeve 508.

In addition, the developer (toner) to be used in the present invention preferably has a mass-average particle diameter in the range of 4 μm or more and 11 μm or less irrespective of its type. The use of such developer establishes a balance between, for example, the charge quantity of the toner or image quality and an image density. Generally, a known resin can be used as the binder resin for a developer (toner). Examples thereof include a vinyl-based resin, a polyester resin, a polyurethane resin, an epoxy resin, and a phenol resin. Of those, a vinyl-based resin and a polyester resin are preferred.

In order to enhance charging characteristics, a charge control agent can be contained in toner particles of the developer (toner) (internal addition) or can be mixed with the toner particles (external addition). This is because the charge control agent enables optimum charge quantity control in accordance with a developing system.

Examples of a positive charge control agent include: a nigrosine-based dye, triaminotriphenylmethane-based dye, and a modified product of a fatty acid metal salt, or the like; a quaternary ammonium salt such as tributylbenzylammonium-1-hydroxy-4-naphthosulfonate or tetrabutylammonium tetrafluoroborate; a diorganotin oxide such as dibutyltin oxide, dioctyltin oxide, or dicyclohexyltin oxide; and a diorganotin borate such as dibutyltin borate, dioctyltin borate, or dicyclohexyltin borate. Those agents may be used alone, or two or more kinds thereof may be used in combination.

In addition, for example, an organometal compound and a chelate compound are each effectively used as a negative charge control agent. Examples thereof include aluminum acetylacetonate, iron(II) acetylacetonate, and chromium 3,5-di-tert-butylsalicylate. In particular, a metal complex such as an acetylacetone metal complex, a monoazo metal complex, or a naphthoic acid- or salicylic acid-based metal complex or salt is preferred.

When the developer (toner) is a magnetic developer (toner), as a magnetic substance, there are given, for example: an iron oxide-based metal oxide such as magnetite, maghemite, or ferrite; a magnetic metal such as Fe, Co, or Ni; an alloy of the metals and a metal such as Al, Cu, Pb, Mg, Ni, Sn, Zn, Sb, Be, Bi, Cd, Ca, Mn, Se, Ti, W, or V; and a mixture thereof. In this case, each of those magnetic substances may also be used as a colorant.

Any of the pigments and dyestuffs used heretofore in the field may be used as the colorant to be blended into the developer (toner), and they may appropriately be selected and used. A release agent is preferably blended into the developer (toner). Examples of the release agent include: aliphatic hydrocarbon-based waxes such as a low-molecular-weight polyethylene, a low-molecular-weight polypropylene, a microcrystalline wax, and a paraffin wax; and waxes each containing a fatty acid ester as a main component such as a carnauba wax, a Fischer-Tropsch wax, a Sasol wax, and a montan wax.

Further, in order to enhance the environment stability, charging stability, developing property, flowability, storability, and cleaning property, it is preferred that inorganic fine powder such as silica, titanium oxide, or alumina be externally added to the developer (toner), that is, the inorganic fine powder be present in the vicinity of the surface of the developer. Of those, the silica fine powder is preferred.

### EXAMPLES

The present invention is described hereinafter by way of specific examples in more detail. First, prior to the examples, production and evaluation of an electro-conductive elastic roller are described. It should be noted that “part(s)” refers to “part(s) by mass.”

(1) Production and Evaluation of Electro-Conductive Elastic Roller 1

Materials shown in Table 1 were kneaded with a 6-L pressure kneader (device used: TD6-15MDX manufactured by Toshin Co., Ltd.) for 20 minutes, and then, 4.5 parts of tetrabenzylthiuram disulfide (trade name: SANCELER TBzTD, manufactured by Sanshin Chemical Industry Co., Ltd.) as a vulcanization accelerator and 1.2 parts of sulfur as a vulcanizing agent were added to the mixture. The mixture was further kneaded for 8 minutes with an open roll having a roll diameter of 12 inches to obtain an unvulcanized rubber composition.

TABLE 1

| Material | Usage |
|---|---|
| Medium high acrylonitrile NBR | 100 parts |
| (Trade name: Nipol DN219, manufactured by | |
| ZEON CORPORATION) | |
| Bonded acrylonitrile content center value: 33.5%, | |
| Mooney viscosity center value: 27 | |
| Carbon black for color (filler) | 48 parts |
| (Trade name: #7360SB, manufactured by TOKAI | |
| CARBON CO., LTD.) | |
| Particle diameter: 28 nm, Nitrogen adsorption | |
| specific surface area: 77 m²/g, DBP adsorption | |
| amount: 87 m²/100 g | |
| Calcium carbonate | 20 parts |
| (Trade name: NANOX #30, manufactured by | |
| MARUO CALCIUM CO., LTD.) | |
| Zinc oxide | 5 parts |
| Zinc stearate | 1 part |

Next, a thermosetting adhesive containing a metal and a rubber (trade name: METALOC N-33, manufactured by TOYO KAGAKU KENKYUSHO CO., LTD.) was applied to a region extending by up to 115.5 mm on both sides each with respect to the center in the axial direction of the columnar surface of a columnar support made of steel having a diameter of 6 mm and a length of 252 mm (having a nickel-plated surface) (region having a total width in the axial direction of 231 mm). The resultant was dried at a temperature of 80° C. for 30 minutes, and was then further dried at a temperature of 120° C. for 1 hour.

Next, the unvulcanized rubber composition was coaxially extruded into a cylindrical shape having an outer diameter of 8.75 to 8.90 mm with a crosshead extruder onto the support with an adhesive layer, and then its ends were cut. Thus, a layer (length: 242 mm) of the unvulcanized rubber composition was formed on the outer periphery of the support. An extruder having a cylinder diameter of 70 mm and an L/D of 20 was used as the extruder. With regard to temperature conditions at the time of the extrusion, the temperature of a head was set to 90° C., the temperature of the cylinder was set to 90° C., and the temperature of a screw was set to 90° C.

Next, the roller was vulcanized with a continuous heating furnace having two zones set to different temperatures. The layer of the unvulcanized rubber composition was vulcanized by being passed through a first zone whose temperature had been set to 80° C. in 30 minutes, and then passed through a second zone whose temperature had been set to 160° C. in 30 minutes. Thus, an elastic layer was obtained. Next, both ends of the elastic layer were cut so that the elastic layer had a width in the axial direction of 232 mm. After that, the surface of the elastic layer was ground with a rotary grindstone. Thus, an electro-conductive elastic roller 1 with crown shape having a diameter at each end of 8.26 mm and a diameter at the central portion of 8.50 mm was obtained.

(Evaluation 1) Evaluation of Electro-Conductive Elastic Roller

The electro-conductive elastic roller 1 was evaluated for the ten-point average roughness (Rz) of its surface and its deflection. The ten-point average roughness Rz was measured in conformity with JIS B0601 (1994). The deflection was measured through use of a high-precision laser measuring machine LSM-430v manufactured by Mitsutoyo Corporation. Specifically, outer diameters of the electro-conductive elastic roller 1 were measured through use of the measuring machine, and a difference between the maximum outer diameter value and the minimum outer diameter value was defined as an outer diameter difference deflection. This measurement was performed at five points, and an average value of the outer diameter difference deflections at the five points was defined as the deflection of the object to be measured. The ten-point average roughness Rz of the surface was 5.5 μm, and the deflection was 18 μm.

### Example 1

### 1. Preparation of Condensate 1

(First Stage Reaction)

The respective materials shown in Table 2 below were supplied to a 300-ml eggplant flask and mixed. After that, the mixture was stirred with a stirrer at room temperature for 30 minutes. Then, the flask was put in an oil bath, and the rotation number of the stirrer was set to 750 rpm. A first stage reaction was performed by subjecting the resultant to reflux under heating at 120° C. for 20 hours, and thus a condensate intermediate 1 of the respective hydrolyzable silane compounds was obtained. The synthesis concentration at this time was 28.0 mass % as a solid content (mass ratio with respect to the total mass of the solution when it was assumed that all the hydrolyzable compounds were subjected to dehydration condensation). It should be noted that Table 3 summarizes the hydrolyzable compounds used in the examples.

TABLE 2

| Material | Usage | |
|---|---|---|
| (Hydrolyzable silane compound) | 11.76 | g |
| Glycidoxypropyl trimethoxysilane (GPTMS, | (0.049 | mol) |
| Abbreviated as “EP-1”) | | |
| (Trade name: KBM-403, manufactured by Shin-Etsu | | |
| Chemical Co., Ltd.) | | |
| (Hydrolyzable silane compound) | 62.49 | g |
| Hexyltrimethoxysilane (HETMS, Abbreviated as “He”) | (0.302 | mol) |
| (Trade name: KBM-3063, manufactured by Shin-Etsu | | |
| Chemical Co., Ltd.) | | |
| Ion-exchange water | 11.39 | g |
| Ethanol (manufactured by KISHIDA CHEMICAL CO., | 91.17 | g |
| LTD., special grade) | | |

TABLE 3

| | | | | Trade |
|---|---|---|---|---|
| Abbreviation | Name | Structure | Manufacturer | name |
| EP-1 | 3-glycidoxypropyl trimethoxysilane | 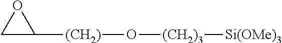 | Shin-Etsu Chemical Co., Ltd. | KBM-403 |
| EP-2 | 3-glycidoxypropyl triethoxysilane | 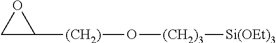 | Shin-Etsu Chemical Co., Ltd. | KBE-403 |
| EP-3 | 4-(trimethoxysilyl)butane- 1,2-epoxide | 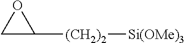 | SiKEMIA | |
| EP-4 | 8-oxirane-2-yloctyl trimethoxysilane | 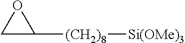 | SiKEMIA | |
| EP-5 | 2-(3,4-epoxycyclohexyl) ethyltrimethoxysilane | 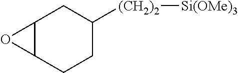 | Shin-Etsu Chemical Co., Ltd. | KBM-303 |
| He | Hexyltrimethoxysilane | H₃C—(CH₂)₅—Si(OMe)₃ | Shin-Etsu | KBM-3063 |
| | | | Chemical | |
| | | | Co., Ltd. | |
| Ph | Phenyltrimethoxysilane | 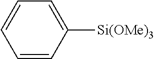 | Shin-Etsu Chemical Co., Ltd. | KBM-103 |
| Ti-1 | Titanium i-propoxide | Ti(OiPr)₄ | Kojundo | |
| | | | Chemical | |
| | | | Laboratory | |
| | | | Co., Ltd. | |
| Ti-2 | Titanium ethoxide | Ti(OEt)₄ | Gelest Inc. | |
| Ti-3 | Titanium nonyloxide | Ti(OC₉H₁₉)₄ | Gelest Inc. | |

(Second Stage Reaction)

Next, 8.90 g of the condensate intermediate 1 were put in a 300-ml eggplant flask. Further, 65.11 g (0.229 mol) of titanium i-propoxide (Ti-1) (manufactured by Kojundo Chemical Laboratory Co., Ltd.) were added to the eggplant flask, and the mixture was stirred at room temperature for 3 hours with the rotation number of the stirrer being set to 750 rpm to obtain a condensate 1. The Ti/Si ratio was 13.0.

### 2. Preparation of Silicone Oil

Next, 90 g of methyl ethyl ketone (MEK) were added to 10 g of terminal silanol-modified diphenyl-dimethyl type silicone oil (trade name: PDS-1615, manufactured by Gelest Inc.) to prepare a 10-mass % oil diluted product 1. Table 4 shows the structure of the phenyl-modified silicone oil.

TABLE 4

| | | | | | Trade |
|---|---|---|---|---|---|
| Kind | Type | Structure | Viscosity | Manufacturer | name |
| 1 2 | Diphenyl- dimethyl type terminal phenol-modified | 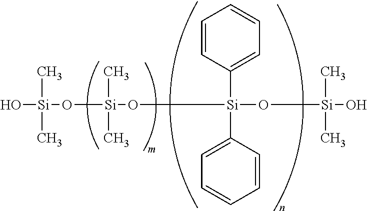 | 50-60 6,000- 8,000 | Gelest Inc. Gelest Inc. | PDS-1615 PDS-0338 |
| 3 4 | Phenylmethyl- dimethyl type terminal- unmodified | 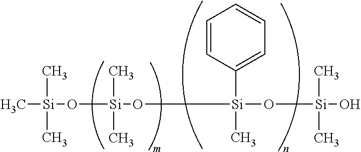 | 100 500 | Dow Corning Toray Co., Ltd. Dow Corning Toray Co., Ltd. | SH510- 100CS SH510- 500CS |
| 5 6 | Diphenyl- dimethyl type terminal- unmodified | 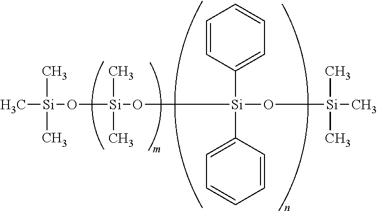 | 100 1,000 | Shin-Etsu Chemical Co., Ltd. Shin-Etsu Chemical Co., Ltd. | KF-50- 100CS KF-50- 1000CS |
| 7 8 | Phenylmethyl type terminal- unmodified | 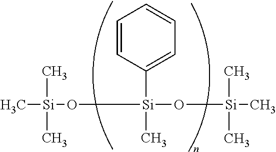 | 10-20 500 | Gelest Inc. Gelest Inc. | PMM-0011 PMM-0025 |
| 9 | Side chain amino-modified silicone oil | 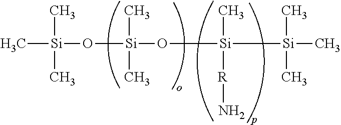 | 230 | Dow Corning Toray Co., Ltd. | FZ-3705 |

### 3. Preparation and Evaluation of Paint for Forming Surface Layer 1

To 100 g of the condensate 1, 8.4 g of the oil diluted product 1 were added and 3.00 g of an aromatic sulfonium salt (trade name: Adecaoptomer SP-150, manufactured by ADEKA Corporation) as a photocationic polymerization initiator diluted to 10 mass % with methanol were further added to obtain a mixed solution 1-2. The blending ratio of the condensate 1 and the phenyl-modified silicone oil was 100:10 (parts by mass).

(Evaluation 2) Confirmation of Structure of General Formula (1)

Next, it was confirmed that a polymer compound in the mixed solution 1-2 had the structure of the general formula (1) through use of ²⁹Si-NMR and ¹³C-NMR measurements (device used: JMN-EX400, JEOL Ltd.). A method of producing a sample for measurement is described as follows.

First, the mixed solution 1-2 was applied to an aluminum sheet (thickness: 100 μm) degreased with alcohol by spin coating (device used; 1H-D7 manufactured by Mikasa Co., Ltd.). The coating was performed under the conditions of the rotation number of 300 rpm and 2 seconds. The coat was dried. Then, the coat was irradiated with ultraviolet rays having a wavelength of 254 nm so that the cumulative light quantity became 9,000 mJ/cm², and thus the coat was cured. For the irradiation with the ultraviolet rays, a low-pressure mercury lamp manufactured by Harison Toshiba Lighting Corporation was used. The cured coat thus obtained was removed from the aluminum sheet and pulverized through use of a mortar made of agate to prepare a sample for NMR measurement. The sample was measured for a ²⁹Si-NMR spectrum and a ¹³C-NMR spectrum.

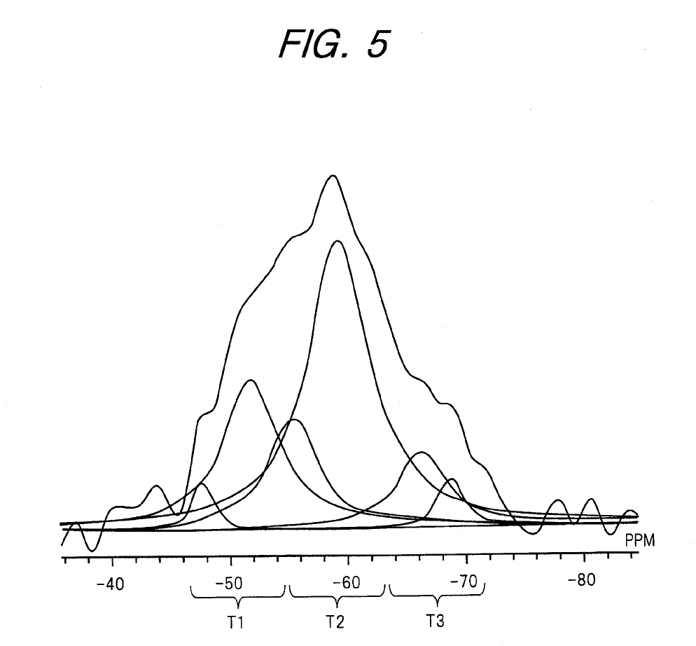

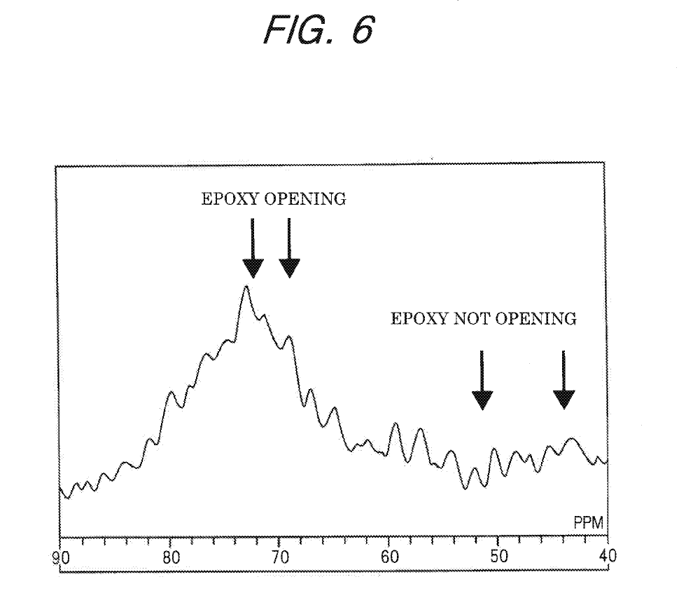

FIG. 5 shows a spectrum obtained by the 29Si-NMR measurement. FIG. 5 also shows peaks obtained by subjecting the spectrum to wave-form separation. The peak in the vicinity of −64 ppm to −74 ppm represents a T³ component. In this case, the T³ component represents a state in which Si having one bond with respect to an organic functional group has three bonds with respect to other atoms (Si, Ti) through 0, that is, —SiO_{3/2}. It was confirmed from FIG. 5 that a hydrolyzable silane compound having an epoxy group was condensed and hence a certain species existed in the state of —SiO_{3/2}. Further, FIG. 6 shows a spectrum obtained by the ¹³C-NMR measurement. Peaks each exhibiting an epoxy group before ring-opening appear in the vicinity of 44 ppm and 51 ppm, and peaks after ring-opening polymerization appear in the vicinity of 69 ppm and 72 ppm. It was confirmed from FIG. 6 that most of epoxy groups which were not opening were polymerized without remaining. It was confirmed from the spectra of ²⁹Si-NMR and ¹³C-NMR that the cured coat of the condensate 1 had the structure of the general formula (1).

On the other hand, separately, the solid content of the mixed solution 1-2 was diluted with a mixed solvent of ethanol and 2-butanol (mass ratio: 1:1) so as to be 1.0 mass % to prepare a paint for forming a surface layer 1. In this case, the solid content also contains a component derived from silicone oil.

### 4. Production and Evaluation of Charging Roller 1

Next, the paint for forming a surface layer 1 was applied by ring application (discharge amount: 0.120 mL/s, speed of a ring portion: 85 mm/s, total discharge amount, 0.130 mL) to an outer circumference of the elastic layer of the electro-conductive elastic roller 1. The resultant was cured (cured by a crosslinking reaction) by being irradiated with ultraviolet rays having a wavelength of 254 nm so that the cumulative light quantity became 9,000 mJ/cm², and thus, a surface layer was formed. For the irradiation with the ultraviolet rays, a low-pressure mercury lamp (manufactured by Harison Toshiba Lighting Corporation) was used. Thus, a charging roller 1 was obtained.

(Evaluation 3) Coatability

The coating state of the surface of the charging roller 1 was determined visually based on the following standard. Table 11 shows the evaluation results.

TABLE 5

| Rank | Evaluation standard |
|---|---|
| A | There are no coating defects on the surface of the |
| | charging roller. |
| B | There are coating defects in part of the surface of |
| | the charging roller. |
| C | There are coating defects in the entire region of |
| | the surface of the charging roller. |

(Evaluation 4) Surface Free Energy

The surface free energy of the charging roller 1 was measured through use of the above-mentioned contact angle meter. Table 11 shows the evaluation results (surface free E).

(Evaluation 5) Coefficient of Kinetic Friction

The coefficient of kinetic friction of the charging roller 1 was measured through use of the measuring device of FIG. 4. The measurement conditions are as described above. Table 11 shows the evaluation results.

Evaluation 6) Confirmation of Si—O—Ti Bond;

The presence of an Si—O—Ti bond in the surface layer of the charging roller 1 was confirmed by ESCA (device used: Quantum 2000 manufactured by Ulvac-Phi, Incorporated). The surface of the charging roller was irradiated with X-rays and the bond form in the surface layer was evaluated. The presence of the Si—O—Ti bond in the surface layer of the charging roller was confirmed by the detected O1s spectrum.

(Evaluation 7) Measurement of Surface Potential of Photosensitive Member

The surface potential of the photosensitive member was measured with a surface potentiometer fixed to the position of a developing member of a process cartridge, from which a developing container had been removed, so as to be perpendicular to the photosensitive member. Specifically, the process cartridge (trade name: “HP35A (CB435A),” manufactured by Hewlett-Packard Japan Ltd.), in which the charging roller 1 was incorporated and the surface potentiometer was fixed, was mounted on a laser beam printer (trade name: “HP LaserJet P1006 Printer,” manufactured by Hewlett-Packard Company), and an all-white image was output. The surface potential of the photosensitive member at this time was measured. Table 11 shows the evaluation results (surface potential of the photosensitive member).

(Evaluation 8) Contact Test of Charging Roller

A contact test was performed through use of the charging roller 1 as described below. The charging roller 1 and the photosensitive member were incorporated into a process cartridge (trade name: “HP35A (CB435A),” manufactured by Hewlett-Packard Company) which was to integrally support the charging roller 1 and the photosensitive member. At this time, a total of 1 kg of a load was applied to the charging roller 1. After that, the charging roller 1 was left under high temperature and high humidity (temperature: 40° C., relative humidity: 95%) for 10 days and 30 days. After the charging roller 1 was removed from the process cartridge, the charging roller 1 was left under normal temperature and normal humidity (temperature: 25° C., relative humidity: 50%) for 72 hours and then mounted on a laser beam printer (trade name: “HP LaserJet P1006 Printer,” manufactured by Hewlett-Packard Company) for A4 sheet vertical output, and an output image was evaluated.

It should be noted that the photosensitive member incorporated into the process cartridge together with the charging roller 1 is an organic electrophotographic photosensitive member obtained by forming an organic photosensitive layer having a thickness of 8.0 μm on a support. Further, the organic photosensitive layer is a laminated photosensitive layer in which a charge-generating layer and a charge-transporting layer containing polycarbonate (binder resin) are laminated from the support side, and the charge-transporting layer serves as a surface layer of the photosensitive member.

Further, a developer (toner) used in the laser beam printer is obtained by blending a colorant, a charge control agent, a release agent, inorganic fine particles, and the like in a binder resin for a developer, and as the type thereof, there are a magnetic one-component developer containing a magnetic substance as an essential component and a non-magnetic one-component developer not containing a magnetic substance. The type is appropriately selected depending on a developing device. In this case, the magnetic one-component developer was used.

The evaluation standard (hereinafter referred to as “C-set rank”) of a streak on an image based on a track due to the contact after the contact test of the charging roller 1 is as described below. The length described in the following evaluation refers to the length of a streak in a lateral direction on an A4 vertical sheet, and the width of the streak is about 1 mm. Table 11 shows the evaluation results.

TABLE 6

| Rank | Evaluation standard |
|---|---|
| 5.0 | No streak is observed on an image. |
| 4.5 | Although a streak can be observed at an end of an |
| | image, the streak is thin and has a length of less |
| | than 5 mm. |
| 4.0 | Although a streak can be observed at an end of an |
| | image, the streak is thin and has a length of 5 mm |
| | or more and less than 10 mm. |
| 3.5 | A streak can be observed at an end of an image, and |
| | has a length of 10 mm or more and less than 15 mm. |
| 3.0 | A streak can be observed at an end of an image, and |
| | has a length of 15 mm or more and less than 30 mm. |
| 2.0 | The length of a streak is 30 mm or more and less |
| | than 70 mm. |
| 1.0 | The length of a streak is 70 mm or more. |

(Evaluation 9) Evaluation of Adhesiveness Resistance of Charging Roller;

The charging roller 1 and the photosensitive member were incorporated into a process cartridge (trade name: “HP36A (CB436A),” manufactured by Hewlett-Packard Company) which was to integrally support the charging roller 1 and the photosensitive member. The process cartridge was mounted on a laser beam printer (trade name: “HP LaserJet P1505 Printer,” manufactured by Hewlett-Packard Company) for A4 sheet vertical output. The charging roller 1 was removed after 2,000 sheets were printed, and the adhesion of toner or an external additive was visually observed. The images in which lateral lines each having a width of 2 dots were drawn at an interval of 100 spaces in a direction perpendicular to the rotation direction of the electrophotographic photosensitive member were formed on an A4 sheet and output in an intermittent output mode including idle rotation for 9 seconds every one sheet under a low-temperature and low-humidity environment (temperature: 10° C., relative humidity: 15%). In the image output in the intermittent output mode, the number of times of rubbing between the charging member and the photosensitive member is large even in the same sheet feeding number as compared with the continuous sheet feeding, and therefore, the contamination of the surface of the charging member is evaluated more strictly. Such images were output from the first (initial) page for 2 days at 1,000 sheets/day (total 2,000 sheets).

The evaluation standard is as described below. Table 11 shows the evaluation results (visual observation of the roller after endurance).

TABLE 7

| Rank | Evaluation standard |
|---|---|
| A | No toner or an external additive adheres to the |
| | charging roller. |
| B | Toner or an external additive slightly adheres to |
| | the charging roller. |
| C | Toner or an external additive adheres to the |
| | charging roller. |

### Example 2 to Example 38

### 1. Preparation of Condensate Intermediates 2 to 9

Condensate intermediates 2 to 9 were prepared in the same way as in the condensate intermediate 1 of Example 1 except that the materials for the first stage reaction were set to the composition described in Table 8 below. It should be noted that, in Table 8, symbols “EP-1” to “EP-5,” “He,” and “Ph” respectively represent the compounds shown in Table 3.

### 2. Preparation of Condensates 2 to 38

Condensates 2 to 38 were synthesized in the same way as in the condensate 1 of Example 1 except that the materials for the second stage reaction were set to the composition shown in Table 9.

### 3. Preparation and Evaluation of Paints for Forming Surface Layer 2 to 38

Mixed solutions 2-2 to 38-2 were prepared in the same way as in the mixed solution 1-2 in Example 1 except that the condensates 2 to 38 were used and the compositions shown in Table 10 were set. The mixed solutions were subjected to the evaluation 2, and it was confirmed that the cured coat of a hydrolyzed condensate of each mixed solution had the structure of the general formula (1). It should be noted that, in Table 10, the kind of silicone oil represents the compound shown in Table 4.

Further, paints for forming a surface layer 2 to 38 were prepared in the same way as in the paint for forming a surface layer 1 except for using the mixed solutions 2-2 to 38-2.

### 4. Production and Evaluation of Charging Rollers 2 to 38

Charging rollers 2 to 38 were produced in the same way as in the charging roller 1 of Example 1 except for using the paints for forming a surface layer 2 to 38, and the charging rollers were subjected to the evaluations 3 to 9. Table 11 shows the evaluation results.

### Comparative Example 1

A condensate 11 was prepared in the same way as in Example 11. Further, side chain amino-modified silicone oil (trade name: “FZ-3705,” manufactured by Dow Corning Toray Co., Ltd.) shown in Table 4 was used instead of the terminal silanol-modified diphenyl-dimethyl type silicone oil 1 used in Example 1. A paint for forming a surface layer C-1 was prepared in the same way as in Example 1 except for the foregoing, and a charging roller C-1 was produced and subjected to the evaluations (3) to (9). Table 11 shows the evaluation results.

### Comparative Example 2

The terminal silanol-modified diphenyl-dimethyl type silicone oil (trade name: “PDS-1615,” manufactured by Gelest Inc.) used in Example 1 was diluted to 10 mass % with MEK to obtain a paint for forming a surface layer C-2. A charging roller C-2 was produced with the operations following the coating set to the same as those of Example 1, and Table 11 shows the evaluation results.

TABLE 8

| Condensate | First stage reaction [g] | | | | | | | | |
|---|---|---|---|---|---|---|---|---|---|
| intermediate | Epoxy-Si | | | | | Other Si | | | |
| No. | EP-1 | EP-2 | EP-3 | EP-4 | EP-5 | He | Ph | H₂O | EtOH |
| 1 | 11.76 | — | — | — | — | 62.49 | — | 11.39 | 91.17 |
| 2 | 71.02 | — | — | — | — | — | — | 9.63 | 96.15 |
| 0 | 39.02 | — | — | — | — | 33.75 | — | 10.58 | 93.46 |
| 4 | 12.15 | — | — | — | — | 22.51 | 48.81 | 11.76 | 81.57 |
| 5 | — | 13.87 | — | — | — | 62.49 | — | 11.39 | 89.05 |
| 6 | — | — | 9.95 | — | — | 65.34 | — | 11.91 | 89.60 |
| 7 | — | — | — | 13.16 | — | 60.10 | — | 10.95 | 92.58 |
| 8 | — | — | — | — | 12.08 | 61.87 | — | 11.28 | 91.57 |
| 9 | 5.85 | — | — | — | 6.07 | 62.18 | — | 11.33 | 91.37 |

TABLE 9

| | Condensate | | | | | |
|---|---|---|---|---|---|---|
| | intermediate | | Ti-1 | Ti-2 | Ti-3 | |
| Conden- | | Blending | Blending | Blending | Blending | |
| sate | | amount | amount | amount | amount | Ti/ |
| No. | No. | [g] | [g] | [g] | [g] | Si |
| 1 | 1 | 8.90 | 65.11 | — | — | 13.0 |
| 2 | | 8.90 | 65.11 | — | — | 13.0 |
| 3 | | 9.20 | 64.80 | — | — | 12.5 |
| 4 | | 9.20 | 64.80 | — | — | 12.5 |
| 5 | | 9.20 | 64.80 | — | — | 12.5 |
| 6 | | 9.20 | 64.80 | — | — | 12.5 |
| 7 | | 34.79 | 39.21 | — | — | 2.0 |
| 8 | | 34.79 | 39.21 | — | — | 2.0 |
| 9 | | 34.79 | 39.21 | — | — | 2.0 |
| 10 | | 47.33 | 26.67 | — | — | 1.0 |
| 11 | | 47.33 | 26.67 | — | — | 1.0 |
| 12 | | 47.33 | 26.67 | — | — | 1.0 |
| 13 | | 57.73 | 16.27 | — | — | 0.5 |
| 14 | | 57.73 | 16.27 | — | — | 0.5 |
| 15 | | 57.73 | 16.27 | — | — | 0.5 |
| 16 | | 70.05 | 3.95 | — | — | 0.1 |
| 17 | | 70.05 | 3.95 | — | — | 0.1 |
| 18 | | 70.05 | 3.95 | — | — | 0.1 |
| 19 | | 70.05 | 3.95 | — | — | 0.1 |
| 20 | | 71.97 | 2.03 | — | — | 0.05 |
| 21 | | 71.97 | 2.03 | — | — | 0.05 |
| 22 | 2 | 50.12 | 23.88 | — | — | 1.0 |
| 23 | 3 | 48.53 | 25.43 | — | — | 1.0 |
| 24 | 4 | 46.77 | 27.23 | — | — | 1.0 |
| 25 | 5 | 47.33 | 26.67 | — | — | 1.0 |
| 26 | 6 | 44.58 | 29.42 | — | — | 1.0 |
| 27 | 7 | 46.05 | 27.95 | — | — | 1.0 |
| 28 | 8 | 45.54 | 28.46 | — | — | 1.0 |
| 29 | 9 | 45.46 | 28.54 | — | — | 1.0 |
| 30 | 1 | 50.95 | — | 23.05 | — | 1.0 |
| 31 | | 33.17 | — | — | 40.83 | 1.0 |
| 32 | | 47.33 | 26.67 | — | — | 1.0 |
| 33 | | 47.33 | 26.67 | — | — | 1.0 |
| 34 | | 47.33 | 26.67 | — | — | 1.0 |
| 35 | | 47.33 | 26.67 | — | — | 1.0 |
| 36 | | 47.33 | 26.67 | — | — | 1.0 |
| 37 | | 47.33 | 26.67 | — | — | 1.0 |
| 38 | | 47.33 | 26.67 | — | — | 1.0 |

TABLE 10

| Paint for forming | Condensate | | Silicone oil | |
|---|---|---|---|---|
| surface layer | | Blending | | Blending |
| No. | No. | amount [g] | Kind | amount [g] |
| 1 | 1 | 100 | 1 | 8.4 |
| 2 | 2 | 100 | | 84 |
| 3 | 3 | 100 | | 8.4 |
| 4 | 4 | 100 | | 84 |
| 5 | 5 | 100 | | 2.8 |
| 6 | 6 | 100 | | 93 |
| 7 | 7 | 100 | | 14 |
| 8 | 8 | 100 | | 28 |
| 9 | 9 | 100 | | 56 |
| 10 | 10 | 100 | | 8.4 |
| 11 | 11 | 100 | | 28 |
| 12 | 12 | 100 | | 84 |
| 13 | 13 | 100 | | 14 |
| 14 | 14 | 100 | | 28 |
| 15 | 15 | 100 | | 56 |
| 16 | 16 | 100 | | 8.4 |
| 17 | 17 | 100 | | 84 |
| 18 | 18 | 100 | | 2.8 |
| 19 | 19 | 100 | | 93 |
| 20 | 20 | 100 | | 8.4 |
| 21 | 21 | 100 | | 84 |
| 22 | 22 | 100 | | 28 |
| 23 | 23 | 100 | | 28 |
| 24 | 24 | 100 | | 28 |
| 25 | 25 | 100 | | 28 |
| 26 | 26 | 100 | | 28 |
| 27 | 27 | 100 | | 28 |
| 28 | 28 | 100 | | 28 |
| 29 | 29 | 100 | | 28 |
| 30 | 30 | 100 | | 28 |
| 31 | 31 | 100 | | 28 |
| 32 | 32 | 100 | 2 | 28 |
| 33 | 33 | 100 | 3 | 28 |
| 34 | 34 | 100 | 4 | 28 |
| 35 | 35 | 100 | 5 | 28 |
| 36 | 36 | 100 | 6 | 28 |
| 37 | 37 | 100 | 7 | 28 |
| 38 | 38 | 100 | 8 | 28 |
| C-1 | 11 | 100 | 9 | 28 |
| C-2 | — | — | 1 | 280 |

TABLE 11

| | | | | | | | | | Evaluation 9 |
|---|---|---|---|---|---|---|---|---|---|
| | | | | Evaluation 5 | | Evaluation 7 | | | Roller visual |
| | | | Evaluation 4 | Coefficient | | Photosensitive | | | observation |
| | Charging | Evaluation 3 | Surface free | of kinetic | Evaluation 6 | member surface | Evaluation 8 | | after |
| | roller | Coatability | E | friction | Si—O—Ti | potential | C-set rank | | endurance |
| | No. | — | mJ/m² | — | bond | −V | 10 days | 30 days | — |
| Example 1 | 1 | B | 26.4 | 0.321 | YES | 491 | 3.5 | 3.0 | B |
| Example 2 | 2 | B | 23.2 | 0.308 | YES | 486 | 4.0 | 3.5 | A |
| Example 3 | 3 | A | 28.2 | 0.359 | YES | 488 | 4.0 | 3.5 | B |
| Example 4 | 4 | A | 22.1 | 0.306 | YES | 485 | 4.0 | 4.0 | A |
| Example 5 | 5 | A | 29.3 | 0.358 | YES | 488 | 3.5 | 3.5 | C |
| Example 6 | 6 | A | 21.4 | 0.313 | YES | 484 | 4.0 | 4.0 | A |
| Example 7 | 7 | A | 26.5 | 0.352 | YES | 486 | 4.5 | 4.5 | B |
| Example 8 | 8 | A | 25.9 | 0.341 | YES | 485 | 5.0 | 4.5 | A |
| Example 9 | 9 | A | 25.2 | 0.339 | YES | 484 | 5.0 | 4.5 | A |
| Example 10 | 10 | A | 27.1 | 0.347 | YES | 486 | 4.5 | 4.5 | B |
| Example 11 | 11 | A | 26.4 | 0.344 | YES | 484 | 5.0 | 4.5 | A |
| Example 12 | 12 | A | 21.1 | 0.321 | YES | 482 | 5.0 | 4.5 | A |
| Example 13 | 13 | A | 27.2 | 0.349 | YES | 485 | 4.5 | 4.5 | B |
| Example 14 | 14 | A | 25.1 | 0.336 | YES | 484 | 5.0 | 4.5 | A |
| Example 15 | 15 | A | 23.7 | 0.327 | YES | 482 | 5.0 | 4.5 | A |
| Example 16 | 16 | A | 27.6 | 0.358 | YES | 487 | 4.0 | 3.5 | B |
| Example 17 | 17 | A | 23.6 | 0.323 | YES | 483 | 5.0 | 4.5 | A |
| Example 18 | 18 | A | 28.7 | 0.364 | YES | 489 | 3.5 | 3.5 | C |
| Example 19 | 19 | A | 22.4 | 0.324 | YES | 485 | 4.5 | 4.0 | A |
| Example 20 | 20 | A | 28.8 | 0.364 | YES | 489 | 3.5 | 3.0 | B |
| Example 21 | 21 | A | 23.6 | 0.327 | YES | 486 | 3.5 | 3.5 | A |
| Example 22 | 22 | A | 25.9 | 0.341 | YES | 485 | 4.5 | 4.5 | A |
| Example 23 | 23 | A | 25.7 | 0.322 | YES | 484 | 5.0 | 4.5 | A |
| Example 24 | 24 | A | 23.6 | 0.318 | YES | 483 | 5.0 | 4.5 | A |
| Example 25 | 25 | A | 26.6 | 0.341 | YES | 484 | 5.0 | 4.5 | A |
| Example 26 | 26 | A | 25.5 | 0.344 | YES | 483 | 5.0 | 4.5 | A |
| Example 27 | 27 | A | 25.9 | 0.333 | YES | 484 | 5.0 | 4.5 | A |
| Example 28 | 28 | A | 26.5 | 0.349 | YES | 484 | 5.0 | 4.5 | A |
| Example 29 | 29 | A | 26.5 | 0.341 | YES | 484 | 5.0 | 4.5 | A |
| Example 30 | 30 | A | 26.5 | 0.351 | YES | 485 | 5.0 | 4.5 | A |
| Example 31 | 31 | A | 26.1 | 0.346 | YES | 485 | 5.0 | 4.5 | A |
| Example 32 | 32 | A | 26.2 | 0.341 | YES | 484 | 5.0 | 4.5 | A |
| Example 33 | 33 | A | 25.9 | 0.339 | YES | 485 | 5.0 | 4.5 | A |
| Example 34 | 34 | A | 25.8 | 0.338 | YES | 484 | 5.0 | 4.5 | A |
| Example 35 | 35 | A | 26.5 | 0.348 | YES | 483 | 5.0 | 4.5 | A |
| Example 36 | 36 | A | 26.1 | 0.339 | YES | 484 | 5.0 | 4.5 | A |
| Example 37 | 37 | A | 26.4 | 0.342 | YES | 486 | 4.5 | 4.0 | A |
| Example 38 | 38 | A | 25.8 | 0.351 | YES | 486 | 4.5 | 4.0 | A |
| Comparative | C-1 | A | 25.2 | 0.332 | YES | 494 | 2.0 | 2.0 | A |
| Example 1 | | | | | | | | | |
| Comparative | C-2 | C | 20.2 | 0.304 | NO | 492 | 2.0 | 2.0 | C |
| Example 2 | | | | | | | | | |

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-129061, filed Jun. 6, 2012, which is hereby incorporated by reference herein in its entirety.

### REFERENCE SIGNS LIST

101 support
102 elastic layer
103 surface layer

What is claimed is:

1. A charging member, comprising:
a support;
an elastic layer; and
a surface layer,
wherein the surface layer comprises:
a constitutional unit represented by the following general formula (1);
a constitutional unit represented by the following general formula (2);
a polymer compound having a bond of Si—O—Ti; and
at least one phenyl-modified silicone oil selected from the group consisting of phenyl-modified silicone oils represented by the following general formulae (7) to (10): 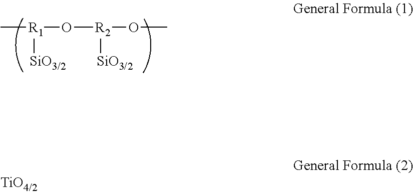
in the general formula (1), R₁ and R₂ each independently represent any of the following general formulae (3) to (6); 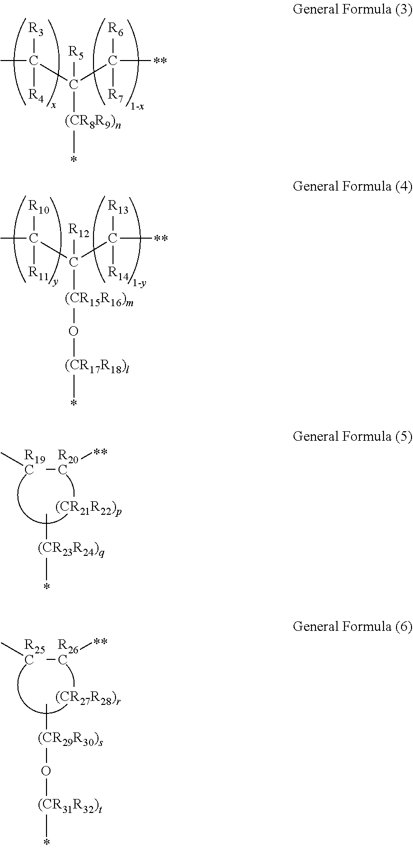
the R₃ to R₇, R₁₀ to R₁₄, R₁₉, R₂₀, R₂₅, and R₂₆ each independently represent a hydrogen atom, an alkyl group having 1 or more and 4 or less carbon atoms, a hydroxyl group, a carboxyl group, or an amino group, R₈, R₉, R₁₅ to R₁₈, R₂₃, R₂₄, and R₂₉ to R₃₂ each independently represent a hydrogen atom, or an alkyl group having 1 or more and 4 or less carbon atoms, R₂₁, R₂₂, R₂₇, and R₂₈ each independently represent a hydrogen atom, an alkoxyl group having 1 or more and 4 or less carbon atoms, or an alkyl group having 1 or more and 4 or less carbon atoms, n, m, l, q, s, and t each independently represent an integer of 1 or more and 8 or less, p and r each independently represent an integer of 4 or more and 12 or less, x and y each independently represent 0 or 1, and “*” and “**” represent sites to be bonded to a silicon atom and an oxygen atom in the general formula (1), respectively; 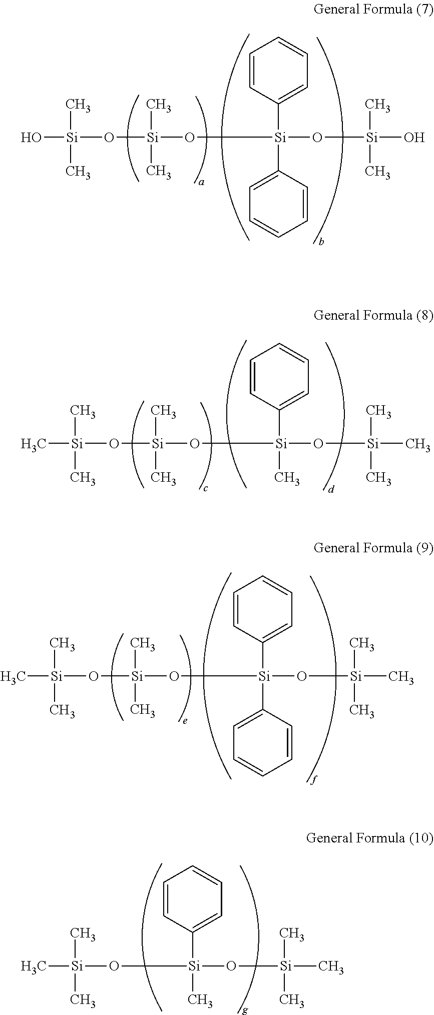
in the general formulae (7) to (10), a to f each independently represent an integer of 1 or more, a+b, c+d, and e+f each independently represent an integer of 2 or more and 670 or less, and g represents an integer of 1 or more and 20 or less.

2. The charging member according to claim 1, wherein in the polymer compound, the R₁ and R₂ in the general formula (1) each independently represent any of the following general formulae (11) to (14): 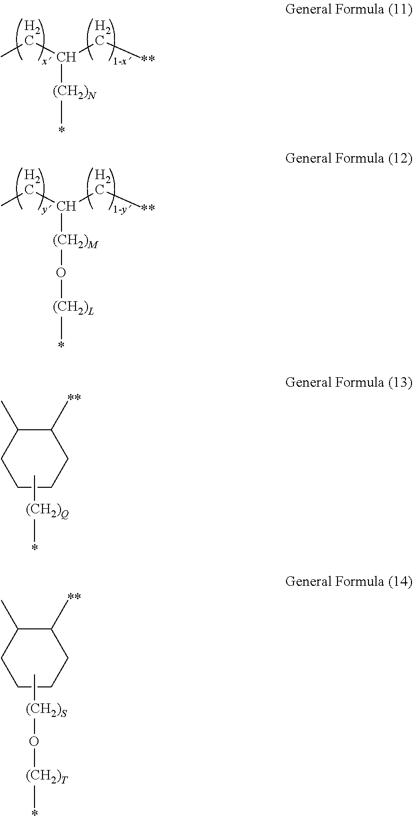
N, M, L, Q, S, and T each independently represent an integer of 1 or more and 8 or less, x′ and y′ each independently represent 0 or 1, and “*” and “**” represent sites to be bonded to a silicon atom and an oxygen atom in the general formula (1), respectively.

3. The charging member according to claim 1, wherein an atomic ratio Ti/Si between titanium and silicon in the polymer compound is 0.1 or more and 12.5 or less.

4. The charging member according to claim 1, wherein the polymer compound comprises a crosslinked product of a hydrolyzed condensate of a hydrolyzable compound having a structure represented by the following general formula (15) and a hydrolyzed condensate of a hydrolyzable compound having a structure represented by the following general formula (16), and has any of the phenyl-modified silicone oils represented by the general formulae (7) to (10):
R₃₃—Si(OR₃₄)(OR₃₅)(OR₃₆) General Formula (15)
Ti(OR₃₇)(OR₃₈)(OR₃₉)(OR₄₀) General Formula (16)
in the general formula (15), R₃₃ represents any of the following general formulae (17) to (20), and R₃₄ to R₃₆ each independently represent an alkyl group having 1 or more and 4 or less carbon atoms, and in the general formula (16), R₃₇ to R₄₀ each independently represent an alkyl group having 1 or more and 9 or less carbon atoms; 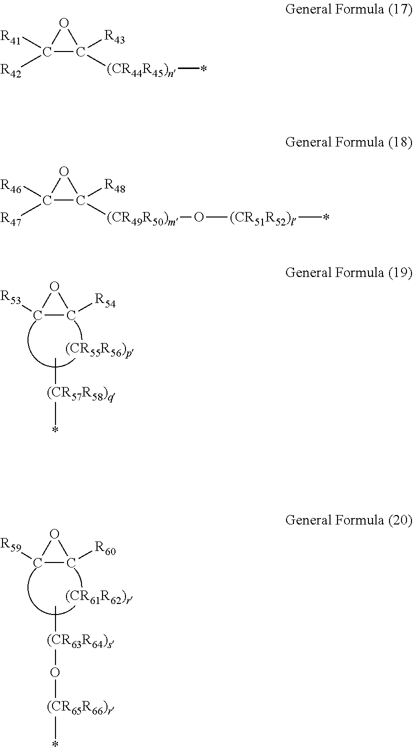
in the general formulae (17) to (20), R₄₁ to R₄₃, R₄₆ to R₄₈, R₅₃, R₅₄, R₅₉, and R₆₀ each independently represent a hydrogen atom, an alkyl group having 1 or more and 4 or less carbon atoms, a hydroxyl group, a carboxyl group, or an amino group, R₄₄, R₄₅, R₄₉ to R₅₂, R₅₇, R₅₈, and R₆₃ to R₆₆ each independently represent a hydrogen atom, or an alkyl group having 1 or more and 4 or less carbon atoms, R₅₅, R₅₆, R₆₁, and R₆₂ each independently represent a hydrogen atom, an alkoxyl group having 1 or more and 4 or less carbon atoms, or an alkyl group having 1 or more and 4 or less carbon atoms, n′, m′, l′, q′, s′, and t′ each independently represent an integer of 1 or more and 8 or less, p′ and r′ each independently represent an integer of 4 or more and 12 or less, and “*” represents a site to be bonded to a silicon atom in the general formula (15).

5. The charging member according to claim 4, wherein the polymer compound comprises a crosslinked product of the hydrolyzed condensate of the hydrolyzable compound having the structure represented by the general formula (15), the hydrolyzed condensate of the hydrolyzable compound having the structure represented by the general formula (16), and a hydrolyzed condensate of a hydrolyzable compound having a structure represented by the following general formula (21), and has any of the phenyl-modified silicone oils represented by the general formulae (7) to (10):
R₆₇—Si(OR₆₈)(OR₆₉)(OR₇₀) General Formula (21)
in the general formula (21), R₆₇ represents an alkyl group having 1 or more and 21 or less carbon atoms or a phenyl group, and R₆₈ to R₇₀ each independently represent an alkyl group having 1 or more and 4 or less carbon atoms.

6. An electrophotographic apparatus, comprising:
an electrophotographic photosensitive member; and
the charging member according to claim 1 arranged in contact with the electrophotographic photosensitive member.

7. A process cartridge, comprising:
an electrophotographic photosensitive member; and
the charging member according to claim 1 arranged in contact with the electrophotographic photosensitive member,
wherein the process cartridge is detachably mountable to a main body of an electrophotographic apparatus.
